(19) United States
(12) Patent Application Publication
(10) Pub. No.: US 2024/0141221 A1
(43) Pub. Date: May 2, 2024

(54) SUB-ZERO PHASE CHANGE MATERIALS WITH MULTIPLE CRYSTALLISATION EVENTS

(71) Applicant: SUNAMP LIMITED, East Lothian (GB)

(72) Inventors: Gylen ODLING, East Lothian (GB); Kate FISHER, East Lothian (GB); David OLIVER, East Lothian (GB)

(21) Appl. No.: 18/279,090

(22) PCT Filed: Mar. 2, 2022
(86) PCT No.: PCT/GB2022/050541

§ 371 Date: Aug. 28, 2023

(30) Foreign Application Priority Data
Mar. 2, 2021 (GB) 2102248.8
Aug. 9, 2021 (GB) 2111449.1

(51) Int. Cl. C09K 5/06

(52) U.S. Cl. CPC C09K 5/066

(57) ABSTRACT

There is disclosed herein compositions of sub-zero salt-water eutectic phase change materials which exhibit two crystallisation processes on cooling. Furthermore, there is disclosed additives which can be used to alter the phase change transitions of one or more of these crystallisation processes.

### FIELD OF THE INVENTION

The invention relates to thermal energy storage, specifically thermal energy storage at temperatures below 0° C. More specifically, the invention relates to the use of inorganic phase change materials (PCMs) as cold storage media and the nucleation thereof.

### BACKGROUND OF THE INVENTION

Cooling systems lack thermal inertia and thermal mass. One solution is to add in a buffer tank, for example a glycol-water mixture, in order to add thermal mass and inertia to the system. However, these systems are undesirable because they have high heat gains from ambient (low efficiency), high purchasing and maintenance costs and low energy density. Such systems require the use of chillers, which use a refrigerant to remove heat from the water-glycol circuit via a heat exchanger, and this is a significant cause of low efficiency.

The use of phase-change materials (PCMs) to store thermal energy is a high energy density alternative to water/glycol tanks. Such materials store energy using the latent heat of a phase change (i.e. solid-liquid, solid-gas, liquid-gas), including polymorphic changes (i.e. solid-solid).

Materials which exhibit phase changes below zero may be organic in nature (i.e. carbon based) or inorganic salt-water eutectics. Compared to organics, inorganic PCMs are typically cheaper, have lower flammability/combustibility and may have higher energy density. However, they exhibit subcooling, a phenomenon where a material which will remain liquid below its thermodynamic phase change temperature and therefore require nucleation aids or extreme low temperatures to initiate crystallisation.

It is an object of at least one aspect of the present invention to obviate or at least mitigate one more of the aforementioned problems.

It is an object of at least one aspect of the present invention to provide a sub-zero phase change material with multiple crystallisation events.

It is an object of at least one aspect of the present invention to provide a sub-zero phase change material with one or more nucleation agents that act to reduce subcooling in one of the crystallisation events specifically.

It is a further object of at least one aspect of the present invention to provide an improved phase change material for cold storage media.

It is a further object of at least one aspect of the present invention to provide a sub-zero phase change material with one or more nucleation agents chosen to reduce subcooling in one crystallisation event, combined with one or more other nucleation agents chosen to reduce subcooling in the other crystallisation event.

It is a benefit of the present invention that the PCM undergoes both crystallisation processes with minimal cooling below the thermodynamic phase transition temperature (i.e. the temperature at which the phase transition could occur with no subcooling).

It is a benefit of the present invention that the PCM may be frozen with a minimum of cooling power, i.e. is frozen at high temperature.

It is a benefit of the present invention that the PCM undergoes both crystallisation phase transitions at a temperature close to (e.g. between 0 and 20° C. below) the thermodynamic phase transition temperature.

### SUMMARY OF THE INVENTION

According to a first aspect of the present invention there is provided a phase change material (PCM) with a melting point below 0° C. which exhibits two crystallisation events on cooling, comprised of:
at least one salt;
water; and
   one or more nucleation agent(s) which act to reduce subcooling in the first crystallisation event, and/or,
   one or more nucleation agent(s) which act to reduce subcooling in the second crystallisation event.

Disclosed herein are compositions of PCMs which exhibit multiple crystallisation events on cooling.

Typically, the salt(s) may be comprised of:
at least one or a combination of cations selected from:
   Lithium;
   Sodium;
   Potassium;
   Calcium;
   Magnesium;
   Strontium;
   Ammonium;
   Iron;
   Copper;
   Manganese;
   Zinc; and/or
   Aluminium;
and at least one or a combination of anions selected from:
   any halide;
   Sulfate;
   Nitrate;
   Phosphate;
   Carbonate;
   any carboxylate or di-carboxylate; and/or
   any deprotonated amino acid.

Typically, the PCM may be comprised of one or more nucleation agent(s) comprising one or more of the following:
Between 0 and 30 wt. % MgSO₄;
Between 0 and 40 wt. % Mg(NO₃)₂;
Between 0 and 30 wt. % MgCl₂;
Between 0 and 35 wt. % CaCl₂);
Between 0 and 50 wt. Ca(NO₃)₂;
Between 0 and 50 wt. % SrBr₂;
Between 0 and 50 wt. NaBr;
Between 0 and 25 wt. NaCl;
Between 0 and 10 wt. % Na₂SO₄;
Between 0 and 25 wt. % NH₄Cl;
Between 0 and 25 wt. % KCl;
Between 0 and 45 wt. % K₂CO₃;
Between 0 and 40 wt. % NaH₂PO₄;
Between 0 and 40 wt. % NaOAc;
Between 0 and 35 wt. % NaOOCH;
Between 0 and 30 wt. % Na₂CO₃;
Between 0 and 35 wt. % LiCl;
Between 0 and 60 wt. % ZnCl₂;
Between 0 and 40 wt. % FeCl₃;
Between 0 and 40 wt. % CuCl₂;
Between 0 and 40 wt. % of BaCl₂;
Between 0 and 25 wt. % KHCO₃;
Between 0 and 40 wt. % Li-, Na- and/or K-benzoate;
Between 0 and 50 wt. % Li-, Na- and/or K-glycolate;
Between 0 and 50 wt. % Li-, Na- and/or K-glycinate;
Between 0 and 50 wt. % Li-, Na- and/or K-propionate;
Between 0 and 50 wt. % Li-, Na- and/or K-β-Alaninate;
Between 0 and 50 wt. % Li-, Na- and/or K-Aspartate;
Between 0 and 50 wt. % Li-, Na- and/or K-Lactate;
Between 0 and 50 wt. % Li-, Na- and/or K-2,2′-bishydroxymethylpropionate;
Between 0 and 50 wt. % Li-, Li₂-, Na-, Na₂-, K- and/or K₂-glutamate;
Between 0 and 40 wt. % Li-, Li₂-, Na-, Na₂-, K- and/or K₂-adipate; and/or
Between 0 and 50 wt. % Li-, Li₂-, Na-, Na₂-, K- and/or K₂-tartrate;
with the remainder of each composition being water.

Preferably, the PCM according to the invention is comprised of one or more nucleation agent(s) selected from one or more of:
Between 3 and 6 wt. % sodium sulfate;
Between 14 and 25 wt. % magnesium sulfate;
Between 25 and 35 wt. % magnesium nitrate;
Between 30 and 40 wt. % sodium nitrate;
Between 20 and 30 wt. % lithium nitrate;
Between 15 and 25 wt. % strontium chloride;
Between 35 and 46 wt. % strontium bromide;
Between 34 and 45 wt. % sodium bromide;
Between 15 and 25 wt. % sodium chloride;
Between 14 and 25 wt. % ammonium chloride;
Between 15 and 25 wt. % potassium chloride;
Between 5 and 15 wt. % sodium-potassium tartrate;
Between 18 and 30 wt. % sodium acetate, and/or
Between 19 and 30 wt. % sodium formate,
with the remainder of each composition being water.

It is a preferred embodiment of the present invention that the PCM comprises one or more salts of group I and/or group II metals.

It is a preferred embodiment of the present invention that the PCM comprises one or more lithium, sodium, potassium, magnesium, calcium, strontium and/or ammonium salts.

It is a preferred embodiment of the present invention that the PCM comprises one or more halide, sulfate, nitrate, carbonate and/or carboxylate salt.

Herein it is defined that the first and second crystallisation events are defined by the order in which they occur chronologically as the PCM is cooled from its liquid state.

The nucleation agent may act to induce nucleation of the first crystallisation transition.

The nucleation agent may act to induce nucleation in the second crystallisation transition.

A plurality of nucleation agents may be used to nucleate both crystallisation events.

It is a preferred embodiment of the present invention to use two or more nucleation agents, with at least one acting to reduce subcooling in the first crystallisation event and at least one acting to reduce subcooling in the second crystallisation event.

In particular embodiments of the invention on cooling nucleation at higher temperature precedes nucleation at a low temperature.

One of the crystallisation events may be a solid-solid phase transition.

The nucleation agent may be selected from at least one oxide, carbonate, carbide, silicate and/or halide of the following: Silicon;
Calcium;
Aluminium;
Titanium;
Iron;
Silver;
Zirconium;
Zinc; and/or
Magnesium.

The nucleation agent may be at least one material selected from a group comprised of:
Silicon dioxide;
Silicon carbide;
Titanium dioxide;
Iron Oxide;
Aluminium oxide;
Silver iodide;
Magnesium oxide;
Zinc oxide;
Vermiculite;
and/or combinations thereof.

The nucleation agent may be a ceramic composite comprised of more than one oxide and/or carbide.

The nucleation agent may be present at a loading of at least 0.01 wt. %, at least 0.1 wt. %, at least 1 wt. %, at least 5 wt. %, at least 10 wt. %, or at least 20 wt. %.

The nucleation agent may be present at a loading of about 0.5 wt. %.

The nucleation agent may be present at a loading greater than the solubility limit of the nucleation agent in the salt solution.

Other aspects of the present invention are set out in the appended claims.

According to further aspect of the present invention there is provided use of a PCM according to the first aspect, wherein the PCM is retained in a solid state after its first crystallisation event before the second crystallisation event occurs. The second crystallisation event can be considered to be a solid-solid phase transition.

A further disclosure as part of the present invention are nucleation agent materials which act to reduce subcooling in one of the crystallisation events exhibited by salt-water eutectic PCMs.

As part of the present invention, it is disclosed that further to subcooling, salt-water eutectics often crystallise at two stages and at two different temperatures.

It is also disclosed herein that the two or at least two crystallisation events in salt-water eutectic PCMs may have distinctly different thermal energies. Control over these two or at least two crystallisation events, including nucleation and crystal growth are highly advantageous towards producing a sub-zero PCM with reliable cyclability, taking advantage of the full thermal capacity of the material.

It is a preferred embodiment of the present invention to use silicon carbide, phyllosilicate materials (e.g. vermiculite, talc or mica) and combinations thereof as nucleation agents to nucleate the second crystallisation event of a salt-water eutectic PCM.

In addition, the application of said control of crystallisation to the operation of a thermal storage device is described.

### BRIEF DESCRIPTION OF THE DRAWINGS

Embodiments of the present invention will now be described, by way of example only, with reference to the following Figures:

FIG. 1 shows the temperature profile of a PCM undergoing a double crystallisation event on cooling according to an embodiment of the present invention;

FIG. 2 shows example thermal data of a PCM (Lithium nitrate-water eutectic) which undergoes a double crystallisation event on cooling according to an embodiment of the present invention;

FIG. 3 shows example thermal data of the disodium adipate-water eutectic where only the one crystallisation event occurs and the subsequent effect of this upon the melting transition according to an embodiment of the present invention;

FIG. 4 shows example thermal data of the disodium adipate-water eutectic where both the first and second crystallisation events occur and the subsequent effect of this upon the melting transition according to an embodiment of the present invention;

FIG. 5 shows thermal data of the sodium acetate-water eutectic where the PCM reaches a higher temperature after the first crystallisation event than the second crystallisation event according to an embodiment of the present invention;

FIG. 6 shows thermal data of the sodium sulfate-water eutectic where the PCM reaches the same temperature after both the first and second crystallisation events, as well as an example of the second crystallisation event initiating at a temperature higher than the first according to an embodiment of the present invention;

FIG. 7 shows thermal data of a material with no known hydrates (KCl) in a eutectic composition with water exhibiting two crystallisation events according to an embodiment of the present invention;

FIG. 8 shows thermal data of a material with a plurality of known hydrates (CaCl₂)) in a eutectic composition with water exhibiting two crystallisation events according to an embodiment of the present invention;

FIG. 9 shows a comparison of the magnesium nitrate-water eutectic with and without a SiC nucleation agent according to an embodiment of the present invention;

FIG. 10 shows thermal data of the double nucleation of the magnesium nitrate-water eutectic without any nucleation agent according to an embodiment of the present invention;

FIG. 11 shows thermal data of the double nucleation of the magnesium nitrate-water eutectic with a ceramic SiO₂/Al₂O₃ nucleation agent according to an embodiment of the present invention;

FIG. 12 shows thermal data of two crystallisation events in the ammonium chloride-water eutectic merging on addition of an ice nucleating protein according to an embodiment of the present invention; and

FIG. 13 shows images of a sub-zero PCM after its first crystallisation event in the process of its second crystallisation event, points 1 and 2 denote areas of PCM after one and two crystallisation events respectively;

FIG. 14 shows a double crystallisation event regime in a large (17 litre) sample of a sub-zero salt-water eutectic PCM comprising sodium acetate and water;

FIG. 15 shows a double crystallisation event regime in a large (100 litre) sample of a sub-zero salt-water eutectic PCM comprising magnesium sulfate and water;

FIG. 16 shows the extent of subcooling of both the first and second crystallisation events in a eutectic of magnesium sulfate and water without any nucleation agent(s);

FIG. 17 shows the extent of subcooling of both the first and second crystallisation events in a eutectic of magnesium sulfate and water with calcium carbonate acting as a nucleation agent for the first crystallisation event and silver iodide acting as a nucleation agent for the second crystallisation event;

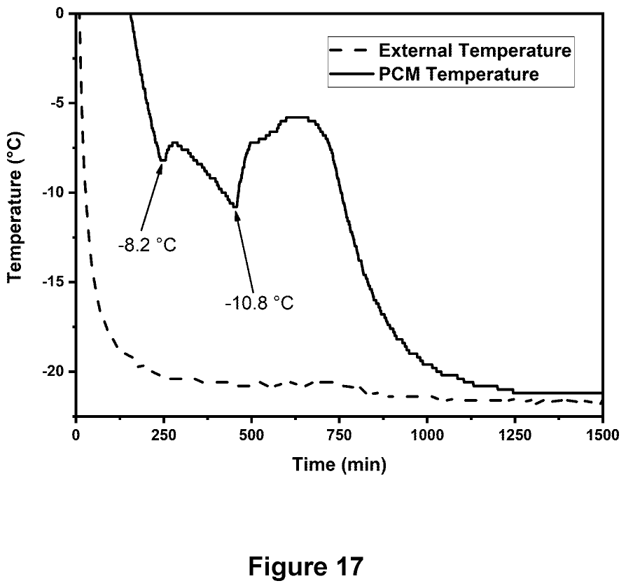

FIG. 18 shows an example thermal cycle of a samples of a magnesium sulfate-water eutectic PCM comprising a titanium dioxide nucleation agent and no nucleation agent;

FIG. 19 shows an example thermal cycle of samples of a magnesium sulfate-water eutectic PCM comprising aluminium oxide and no nucleation agent;

FIG. 20 shows an example thermal cycle of samples of a magnesium sulfate-water eutectic PCM comprising silicon carbide and no nucleation agent;

FIG. 21 shows an example thermal cycle of samples of a sodium bromide-water eutectic PCM comprising aluminium oxide and no nucleation agent;

FIG. 22 shows an example thermal cycle of samples of a sodium bromide-water eutectic PCM comprising silicon dioxide and no nucleation agent;

FIG. 23 shows an example thermal cycle of samples of a sodium bromide-water eutectic PCM comprising calcium carbonate and no nucleation agent;

FIG. 24 shows an example thermal cycle of samples of a sodium bromide-water eutectic PCM comprising silver iodide and no nucleation agent;

FIG. 25 shows cooling of a PCM comprising a sodium acetate-water eutectic with no nucleation agent in a 3-layer calorimetry set up;

FIG. 26 shows cooling of a PCM comprising a sodium acetate-water eutectic with a silver iodide nucleation agent in a 3-layer calorimetry set up;

FIG. 27 shows an example thermal cycle of samples of a strontium bromide-water eutectic PCM comprising silver iodide and no nucleation agent;

FIG. 28 shows an example thermal cycle of samples of a potassium chloride-water eutectic PCM comprising silver iodide and no nucleation agent;

FIG. 29 shows an example thermal cycle of samples of an ammonium chloride-water eutectic PCM comprising silver iodide and no nucleation agent;

FIG. 30 shows the effect of adding titanium dioxide to a KCl-water salt-water eutectic PCM, with an improvement to the first crystallisation event; and

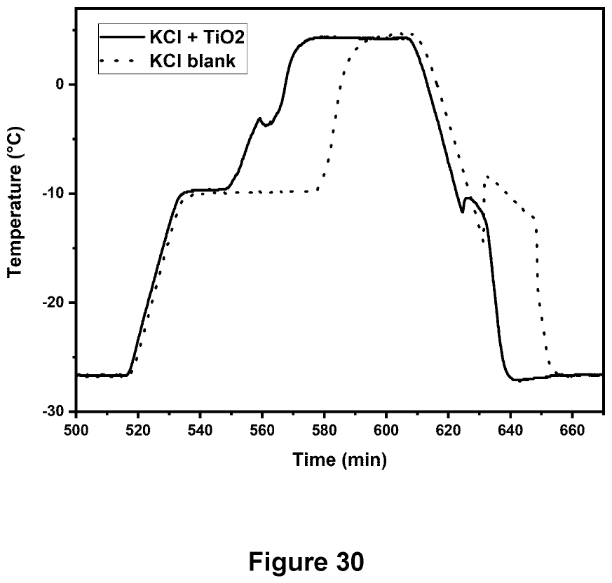

FIG. 31 shows changing the cation of the salt to sodium however gives reversed performance, with the addition of titanium dioxide improving the nucleation of the second crystallisation event;

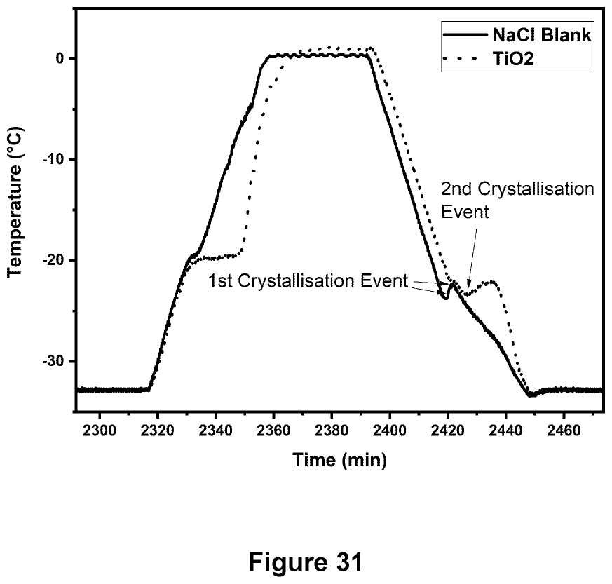

FIG. 32 shows the use of Agl to improve the first crystallisation event of a PCM comprising a magnesium sulfate-water eutectic;

FIG. 33 shows the use of Agl and SiC to improve the first and second crystallisation events of a PCM comprising a sodium sulfate-water eutectic;

FIG. 34 shows the two stage crystallisation of a PCM comprising a lithium sulfate-water eutectic (i.e. approx. 25 wt. % lithium sulfate in water) without any nucleation agent;

FIG. 35 shows improved nucleation of the first crystallisation event of a potassium chloride-water eutectic when modified with calcium carbonate;

FIG. 36 shows vermiculite allowing the second crystallisation event to occur in an ammonium chloride-water eutectic compared to a blank;

FIG. 37 shows the presence of calcium carbonate improving the crystallisation of the first crystallisation event of a eutectic of NH₄Cl and water;

FIG. 38 shows the improvement to the first crystallisation event of a eutectic of sodium acetate and water due to the presence of iron oxide;

FIG. 39 shows the improvement to the first crystallisation event of a eutectic of sodium acetate and water due to the presence of calcium carbonate;

FIG. 40 shows the improvement of the second crystallisation event of a eutectic of sodium formate and water due to the presence of vermiculite;

FIG. 41 shows the improvement of the second crystallisation event of a eutectic of sodium formate and water due to the presence of silicon carbide;

FIG. 42 shows the crystallisation of a eutectic of sodium formate and water without any nucleation agent;

FIG. 43 shows the crystallisation of a eutectic of sodium formate and water with a silver iodide nucleation agent;

FIG. 44 shows improvements to the second crystallisation event of a PCM comprising a strontium chloride-water eutectic in the presence of silicon carbide and silver iodide;

FIG. 45 shows improvements to the first crystallisation event of a PCM comprising a strontium chloride-water eutectic in the presence of aluminium oxide;

FIG. 46 shows improvements to the first crystallisation event of a PCM comprising a sodium nitrate-water eutectic in the presence of calcium carbonate;

FIG. 47 shows improvements to the first crystallisation event of a PCM comprising a sodium chloride-water eutectic in the presence of calcium carbonate;

FIG. 48 shows improvements to the second crystallisation event of a PCM comprising a sodium chloride-water eutectic in the presence of vermiculite;

FIG. 49 shows improvements to the first crystallisation event of a PCM comprising a lithium nitrate-water eutectic in the presence of iron oxide;

FIG. 50 shows improvements to the second crystallisation event of a PCM comprising a lithium nitrate-water eutectic in the presence of silicon carbide;

FIG. 51 shows improvements to the first crystallisation event of a PCM comprising a sodium bromide-water eutectic in the presence of alumina;

FIG. 52 shows improvements to the first crystallisation event of a PCM comprising a strontium bromide-water eutectic in the presence of calcium carbonate;

FIG. 53 shows the freezing profile of a PCM comprising Rochelle's salt and water;

FIG. 54 shows the freezing profile of a PCM comprising Rochelle's salt, water and calcium carbonate;

FIG. 55 shows improvements to the second crystallisation event of a PCM comprising a magnesium sulfate-water eutectic in the presence of calcium carbonate;

FIG. 56 shows improvements to the first crystallisation event of a PCM comprising a potassium chloride-water eutectic in the presence of calcium carbonate;

FIG. 57 shows improvements to the first crystallisation event of a PCM comprising an ammonium chloride-water eutectic in the presence of aluminium oxide;

FIG. 58 shows improvements to the second crystallisation event of a PCM comprising an ammonium chloride-water eutectic in the presence of silicon carbide;

FIG. 59 shows improvements to the second crystallisation event of a PCM comprising a strontium chloride-water eutectic in the presence of vermiculite;

FIG. 60 shows improvements to the second crystallisation event of a PCM comprising a sodium nitrate-water eutectic in the presence of vermiculite;

FIG. 61 shows improvements to the second crystallisation event of a PCM comprising a sodium nitrate-water eutectic in the presence of aluminium oxide;

FIG. 62 shows improvements to the first crystallisation event of a PCM comprising a sodium nitrate-water eutectic in the presence of iron oxide;

FIG. 63 shows improvements to the first crystallisation event of a PCM comprising a sodium nitrate-water eutectic in the presence of silicon oxide;

FIG. 64 shows improvements to the first crystallisation event of a PCM comprising a sodium acetate-water eutectic in the presence of calcium carbonate;

FIG. 65 shows improvements to the first crystallisation event of a PCM comprising a sodium chloride-water eutectic in the presence of aluminium oxide;

FIG. 66 shows improvements to the second crystallisation event of a PCM comprising a sodium chloride-water eutectic in the presence of silicon carbide;

FIG. 67 shows TiO₂ triggering the second crystallisation event in a PCM comprising a lithium nitrate-water eutectic;

FIG. 68 shows SiO₂ improving the second crystallisation event of a PCM comprising a lithium nitrate-water eutectic. Note—the anomaly denoted artefact is due to a nearby sample warming on crystallisation and is not due to the samples described in the figure; and

FIG. 69 shows vermiculite improving the second crystallisation event of a PCM comprising a potassium chloride-water eutectic.

### DETAILED DESCRIPTION

The present invention relates to the use of inorganic phase change materials (PCMs) as cold storage media and the nucleation thereof.

Herein is disclosed a range of salt-water eutectics that have phase transition temperatures between about 0 and about −100° C. and exhibit a two-stage crystallisation event.

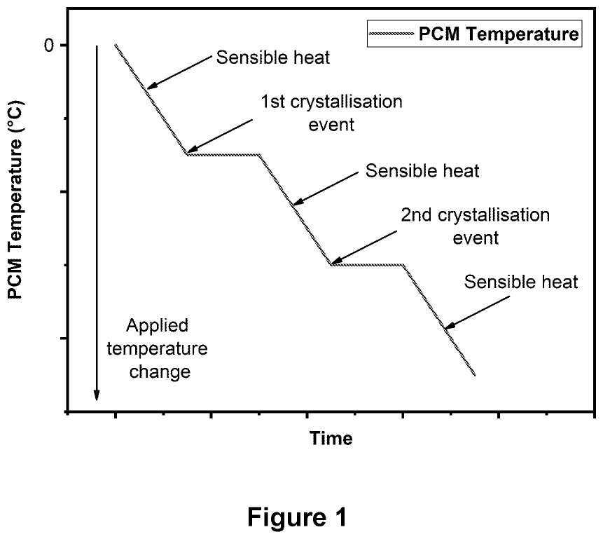

A two-stage crystallisation event is described pictorially in FIG. 1. The PCM is shown to be cooled by an external source of cooling, causing the PCM's internal temperature to fall. Initially the PCM temperature falls according to the sensible heat of the PCM, until a certain temperature is reached. At this point the first crystallisation event occurs, releasing heat as the PCM crystallises. Once this first phase change is complete, the PCM temperature then begins to fall again according to the sensible heat of the material. At a second lower temperature, a further crystallisation event is observed, and heat is released once again. After this second nucleation/crystallisation stage, the PCM continues to cool according to its sensible heat.

Herein it is defined that the first and second crystallisation events are defined by the order in which they occur chronologically as the PCM is cooled from its liquid state.

However, experimentally several different potential regimes may be observed depending on the composition of the PCM.

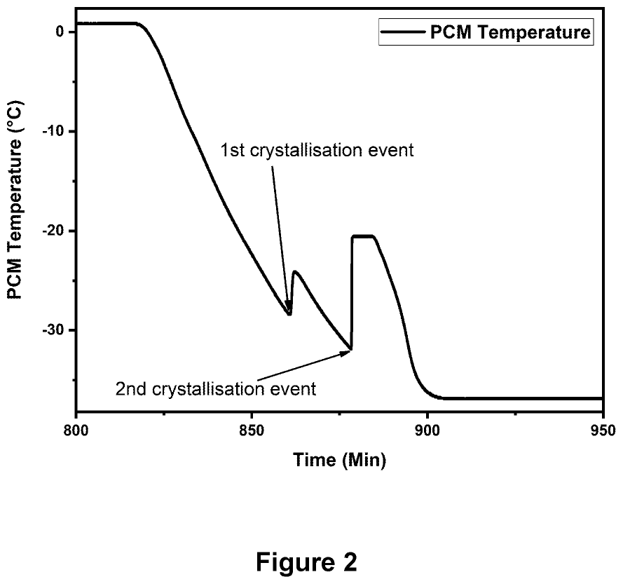

FIG. 2 shows a typical double crystallisation plot of a lithium nitrate-water sub-zero PCM where subcooling is observed in both transitions. The lithium nitrate-water eutectic is disclosed to have a thermodynamic phase transition at about −21° C., however on cooling the two crystallisation events are observed initiating at about −28° C. and about −32° C., indicating subcooling. Hence this PCM without any additives would need to be cooled to about −32° C. for it to be fully crystallised, despite appearing solid after cooling to about −28° C.

Subcooling may be more extreme than is noted in FIG. 2, where the low temperature crystallisation event sub-cools to such an extent that only a single crystallisation event occurs within the temperature window used.

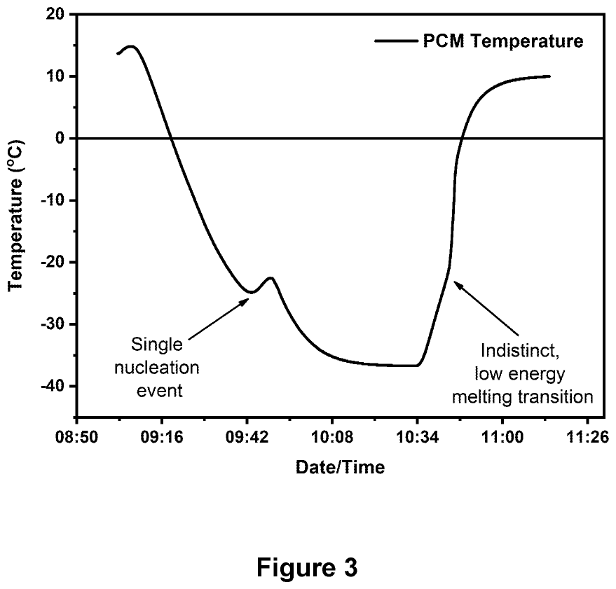

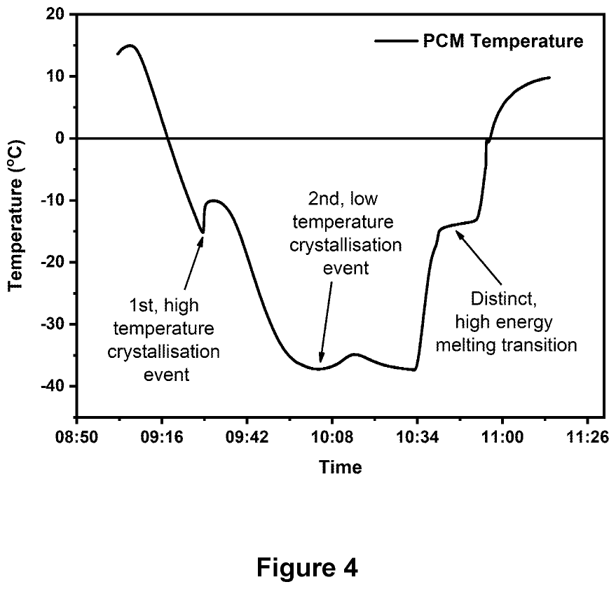

FIG. 3 shows experimental data of a eutectic of disodium adipate and water which undergoes its first crystallisation event but not its second crystallisation event. This leads to incomplete freezing of the PCM, the result of which is that on warming the PCM only a very indistinct melting plateau is observed. In contrast, where this PCM undergoes both its crystallisation events (FIG. 4), a distinct flat melting transition is observed at around −14° C. Hence, it is key in the salt-water eutectic PCMs disclosed herein that both the first and second crystallisation events occur and thereby achieve maximum energy storage at a single, well-defined temperature.

Furthermore, the maximum output temperature of a sub-zero PCM with multiple nucleation events may be weighted more towards the crystallisation process initiated by the first or second crystallisation events.

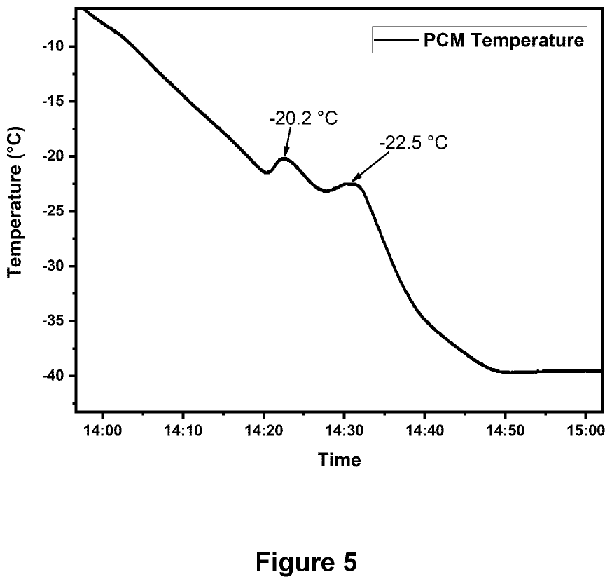

For example, FIG. 2 shows that the thermodynamic maximum freezing temperature of about −21° C. is reached after the second crystallisation event for the lithium nitrate-water eutectic, whereas FIG. 5 shows that the sodium acetate-water eutectic that has a thermodynamic phase transition temperature of about −20° C. only reaches this temperature after the first crystallisation event and not the second one. Without wishing to be bound by any particular theory, this effect is suggested to be due to a combination of sub-cooling and crystal growth rate.

Another eventuality is that both crystallisation stages produce the same output temperature after each crystallisation event.

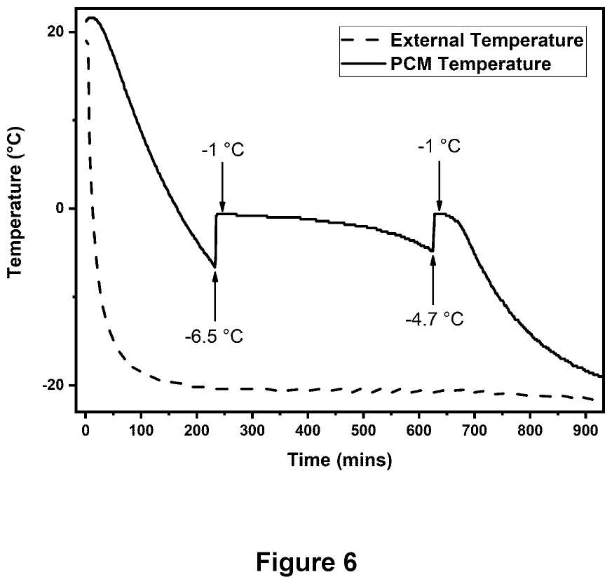

FIG. 6 shows the crystallisation of a sodium sulfate-water eutectic in two stages, with both crystallisation stages reaching about −1° C. after initiation of crystallisation. Little sub-cooling and fast crystallisation may result in the regime described in FIG. 6.

A further key disclosure which is demonstrated in FIG. 6 is that the temperatures of the first and second crystallisation events may be highest first or lowest first. For example, when cooling a PCM, the first crystallisation event chronologically may be either lower or higher in temperature than the second.

It is disclosed herein that salts of halides, nitrates, sulfates and carboxylic acids (such as acetates or formates), and their mixtures exhibit said multiple crystallisation events.

The PCMs disclosed herein may be comprised of at least one salt with at least one or moreof cations selected from a group comprised of:

Lithium;
Sodium;
Potassium;
Calcium;
Magnesium;
Strontium;
Ammonium;
Iron;
Copper;
Manganese; and/or
Zinc;
   and at least one or more of anions selected from a group comprised of:

Any halide;

Sulfate;
Nitrate;
Phosphate;
Carbonate;
any carboxylate, di-carboxylate or tri-carboxylate; and/or
any deprotonated amino acid.

It is a preferred embodiment of the present invention that the PCM comprises one or more salts of group I and/or group II metals.

It is a preferred embodiment of the present invention that the PCM comprises one or more lithium, sodium, potassium, magnesium, calcium, strontium and/or ammonium salts.

It is a preferred embodiment of the present invention that the PCM comprises one or more halide, sulfate, nitrate, carbonate and/or carboxylate salt.

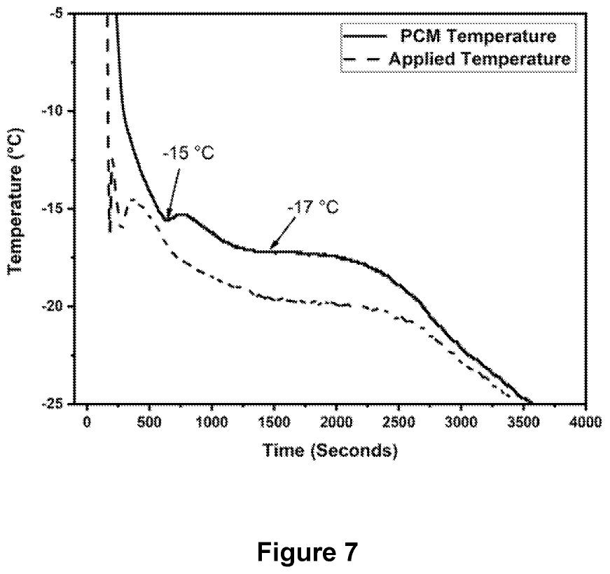

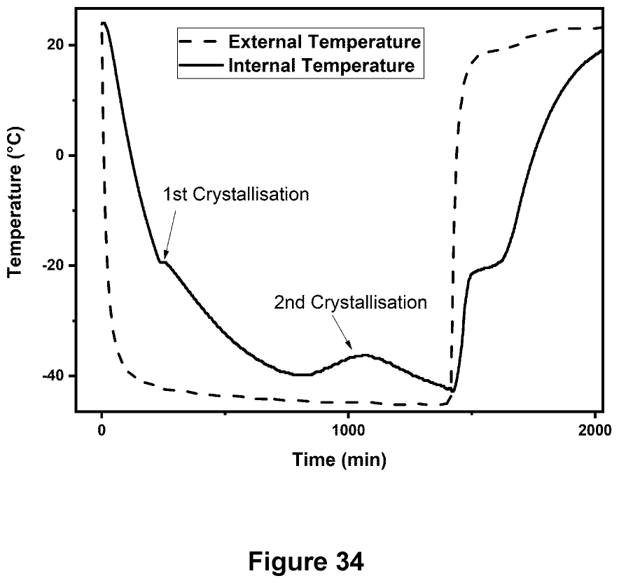

It is noted herein that this double crystallisation effect can be observed in salt-water eutectics where the salt in question has one or more known hydrates. For example the sodium acetate-water eutectic described in FIG. 5, or the lithium sulfate-water eutectic, a thermal cycle of which is shown in FIG. 34. However, it is disclosed herein that it is also observable where the salt has no known hydrate forms (i.e. the potassium chloride-water eutectic described in FIG. 7). Thus, the technical benefit of controlling these nucleation events is expanded to salt without hydrate forms as well as salts with hydrate forms.

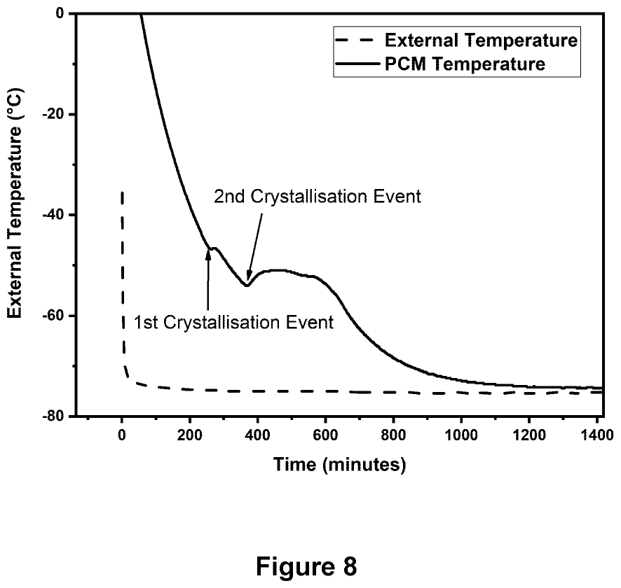

Furthermore, it is disclosed herein that even salts with a plurality of hydrate forms tend to exhibit only two distinct crystallisation events. In FIG. 8, a PCM comprising calcium chloride and water is shown to exhibit a double crystallisation regime in the same manner as other salt-water eutectics. It is noteworthy however to note that calcium chloride is known to exist in mono-, di-, tetra- and hexahydrate forms, yet it exhibits only two crystallisation steps when used as a salt-water eutectic. Therefore, it is disclosed herein that the double crystallisation effect of salt-water eutectics is independent of the number of crystalline hydrate forms available. The inventors note that a salt-water eutectic will exhibit two crystallisation events.

The invention discloses materials which may be used to aid nucleation of one of the crystallisation events of a salt-water eutectic. Providing materials which aid in nucleation ensure that both crystallisation stages are completed before the material is warmed, and therefore allows the full use of the PCM as a thermal energy storage medium. Said nucleation agents also decrease the temperature below which the PCM must be cooled to ensure nucleation for one, or both, of the phase transitions. It is a further disclosure of the present invention that multiple nucleation agents that each individually act to reduce subcooling in one of the crystallisation transitions may be combined to overcome subcooling in both crystallisation transitions.

Herein, it is disclosed that metal oxides, carbides, silicates, halides, and combinations thereof are effective nucleation agents for at least one of the phase transitions observed in sub-zero salt-water eutectic PCMs.

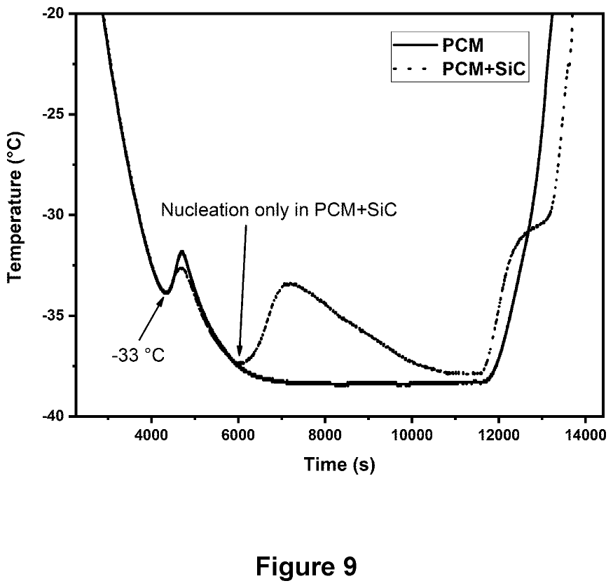

The nucleation agent may be effective on one of the two phase transitions but not the other. For example, as shown in FIG. 9 silicon carbide (SiC) is an effective nucleation agent for the second crystallisation event of the magnesium nitrate-water eutectic. Without the SiC nucleation agent, the PCM does not undergo the second crystallisation phase transition and thereby does not exhibit any noticeable melting transition when warmed. Conversely, the SiC containing PCM does exhibit both transitions and shows a melting transition at around −30° C. Meanwhile, the first crystallisation event is largely unaffected by the addition of SiC.

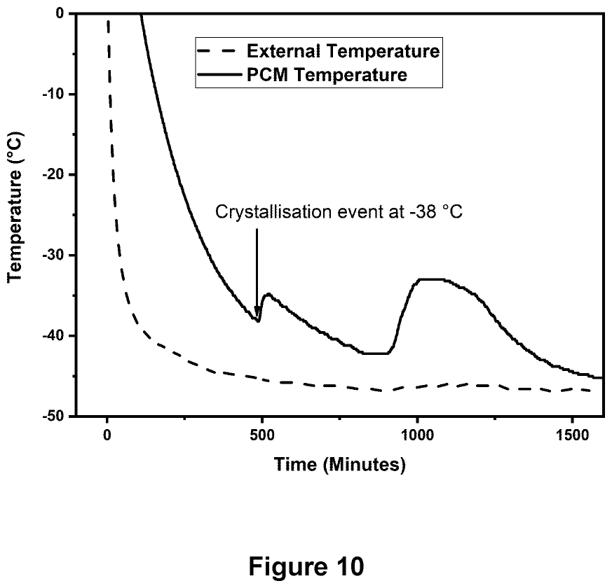

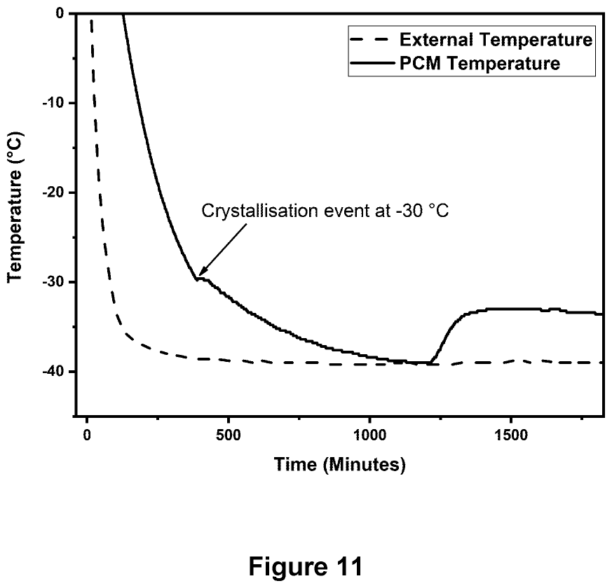

Nucleation agents may also affect only the first crystallisation event. For example, a ceramic composite comprised of alumina and silica is disclosed as an effective nucleation agent for the first, high temperature nucleation event of the magnesium nitrate-water eutectic. FIG. 10 shows this eutectic without any nucleation agent present, where the first crystallisation event occurs at about −38° C. In contrast, when the PCM contains the ceramic nucleation agent, this phase transition occurs at about −30° C., the thermodynamic phase transition temperature for this eutectic (FIG. 11).

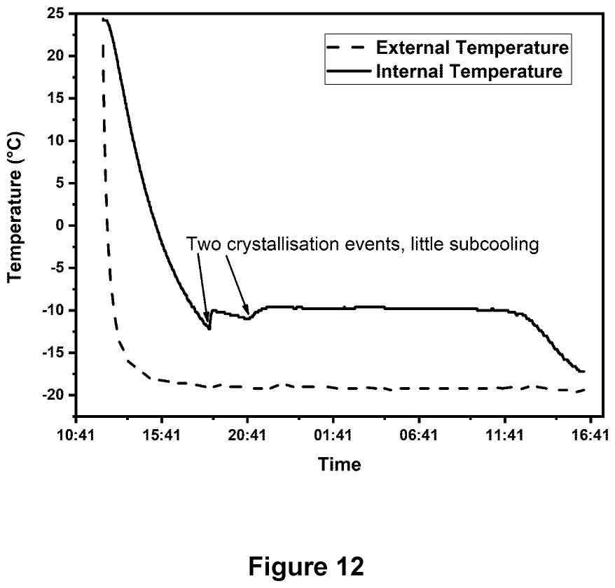

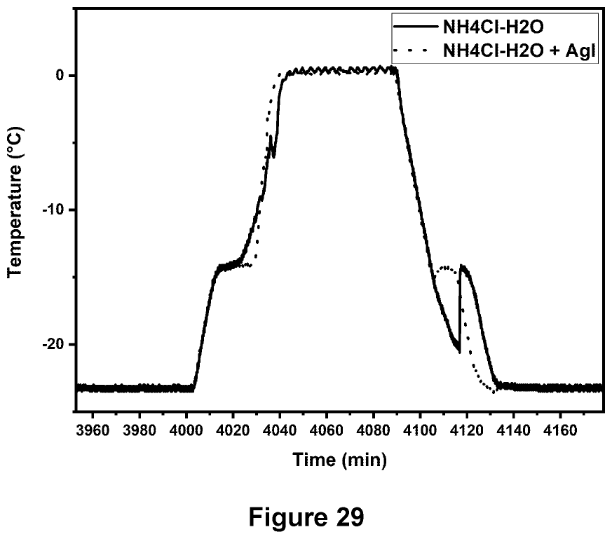

Ice nucleating proteins are disclosed herein as effective nucleation agents for the first crystallisation event. FIG. 12 shows the ammonium chloride-water eutectic that has been modified using ice-nucleating proteins. While two crystallisation events are observable in the plot, minimal subcooling is observed in the first compared to a sample without any nucleation agent (i.e. FIG. 29), and therefore ice nucleating proteins can be determined to be a nucleation agent for the first crystallisation event.

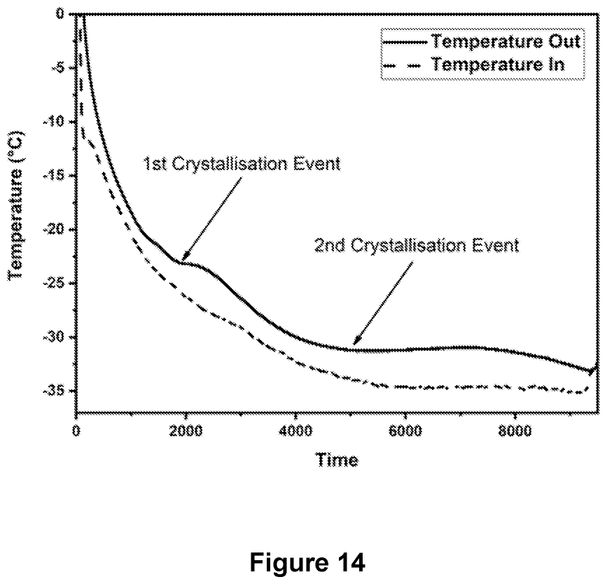

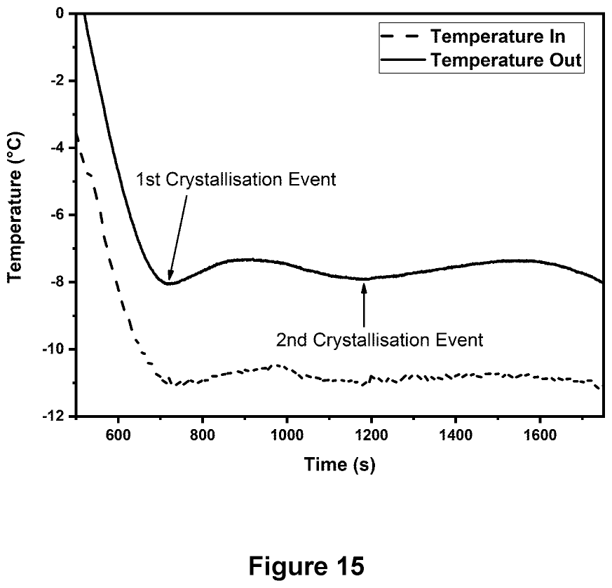

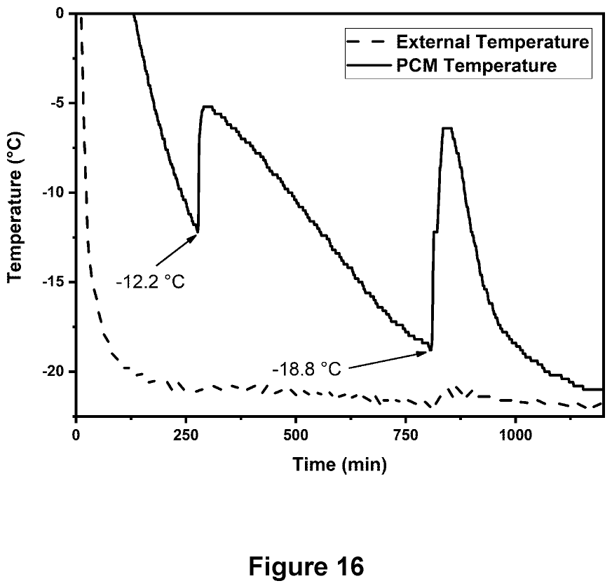

Nucleation is known to be a stochastic process, and thus crystallisation is generally improved by increasing the sample size as the probability of a stable nucleation point being forming increases with increasing sample size. Considering this, it could be expected that the double nucleation profile of sub-zero salt-water eutectic PCMs would differ at large scales. However, it is disclosed herein that this is not the case, and that even at very large (i.e. >1 L) scales that such PCMs still exhibit two distinct crystallisation events. FIG. 14 shows the crystallisation of 17 L of a sodium acetate water eutectic proceeding in two stages, with the second crystallisation event only being observed below about −30° C., far removed from the thermodynamic phase change temperature of about −18° C. In the same fashion as with smaller samples, it has been found by the inventors that at this increased scale that both crystallisation events must occur to fully access the energy storage capacity of the PCM. Thus, without a nucleation agent, crystallisation of salt-water eutectic PCMs even at large scales requires an excess of cooling. With a nucleation agent as defined herein however, minimal subcooling can be achieved in large PCM samples as well as smaller ones. FIG. 15 shows the double crystallisation of a large (c.a. 100 L) sample of the eutectic of magnesium sulfate and water with a combination of calcium carbonate and silver iodide nucleation agents, known to the inventors to improve nucleation in the first and second crystallisation events respectively (see FIGS. 16 & 17 fora comparison). Minimal subcooling below the thermodynamic phase change temperature of about −5° C. can be observed in both the first and second nucleation events, however both are still distinguishable from one another. Thus, it is demonstrated that two crystallisation events are to be expected when fully freezing salt-water eutectic PCMs, and that nucleation agents that act on one of the crystallisation events are effective even at very large scales.

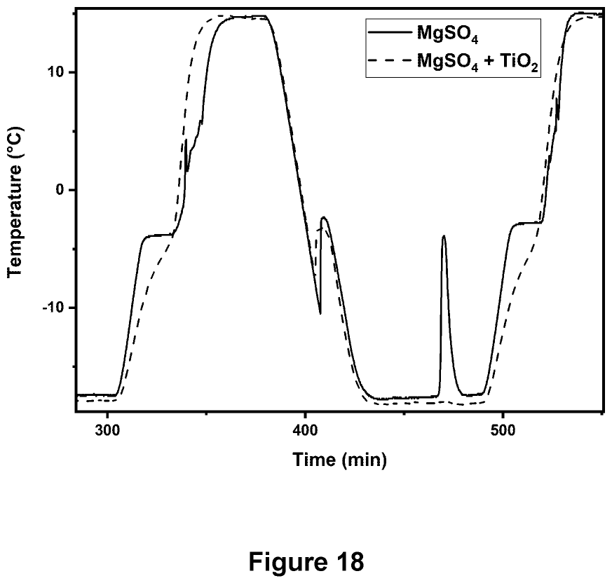

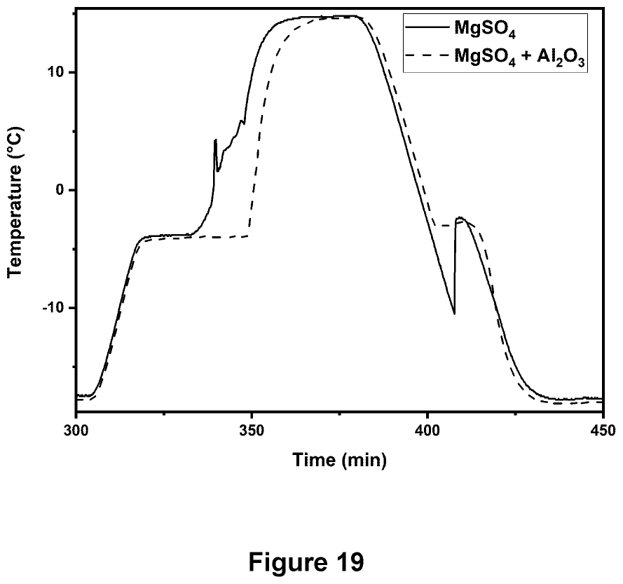

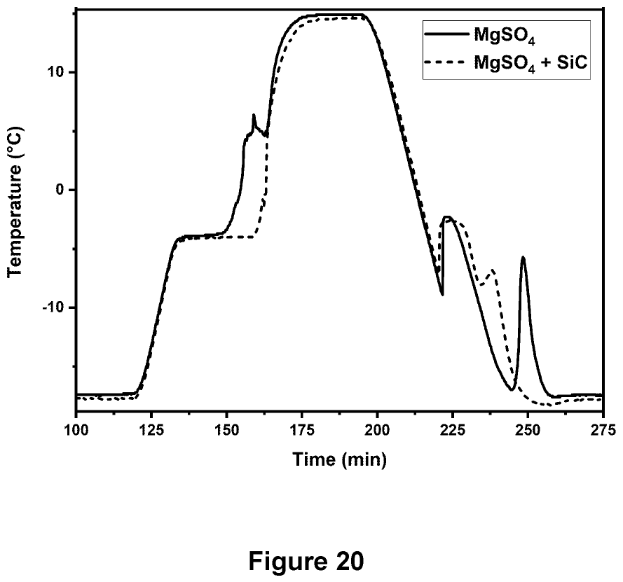

By way of further non-limiting example, a PCM comprised of magnesium sulfate, water and one or more nucleation agents may be considered. FIG. 18 shows a comparison of a typical thermal cycle of two samples of such a PCM, one comprising a titanium dioxide nucleation agent, and the other without any nucleation agent. Improvements to the first crystallisation event can be noted for the sample comprising titanium dioxide, but no improvement in the second crystallisation event can be observed. The blank sample does eventually undergo the second crystallisation event, however only after exhibiting significant subcooling. It was found by the inventors that this second crystallisation event in the blank was unreliable, and would not occur on every thermal cycle. Thus, the melting transition of the blank and the sample comprising titanium dioxide were often broad, however clear improvements to the first crystallisation event can be gained by the use of titanium dioxide. A similar test using an aluminium oxide nucleation agent demonstrated improvements to the first crystallisation event, and subsequent full crystallisation (FIG. 19). Alumina is shown to raise the temperature at which the first crystallisation event occur, and thus are an aid to nucleation for the first crystallisation event. This improved crystallisation may also aid in inducing the second crystallisation event due in part to the material being partially or wholly solid before the second crystallisation occurs. Contrastingly, as shown in FIG. 20, it has been found by the inventors that silicon carbide is a selective nucleation agent for the second crystallisation event. In FIG. 20, the magnesium sulfate-water eutectic also comprising silicon carbide shows no improvement in the crystallisation temperature of the first crystallisation event, but a marked increase in the temperature at which the second crystallisation event occurs. Thus, silicon carbide is demonstrated as a selective nucleation agent for the second crystallisation event.

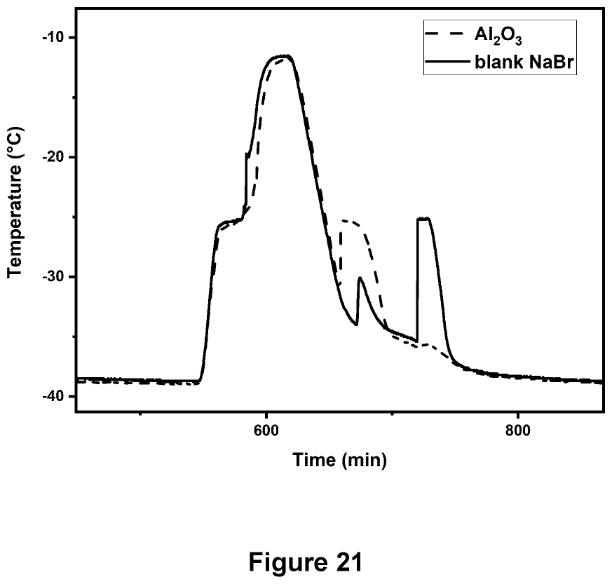

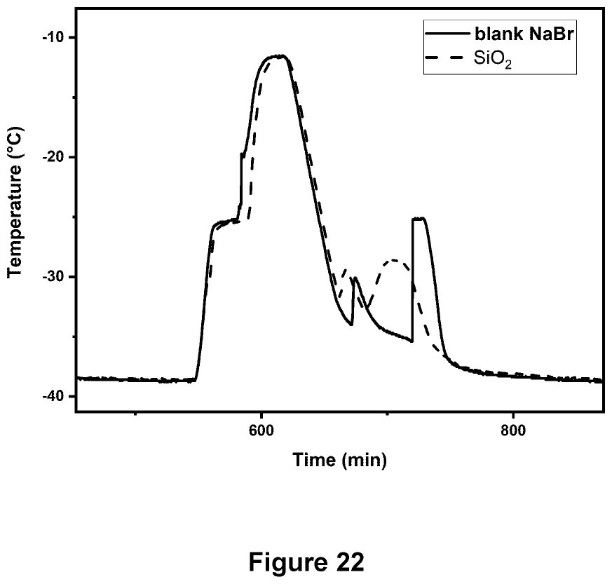

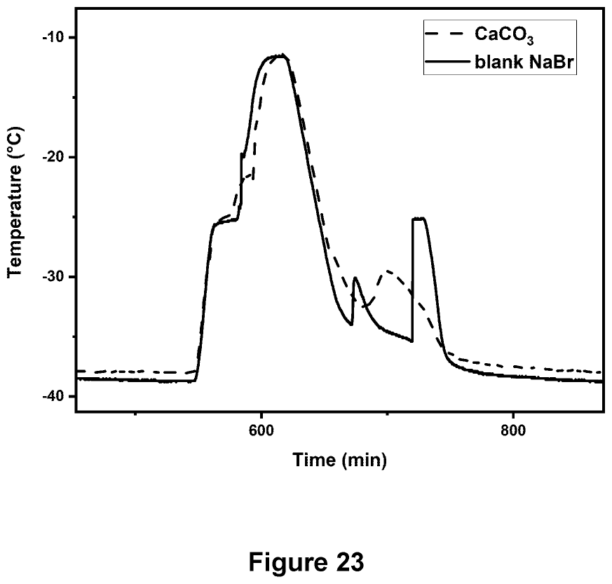

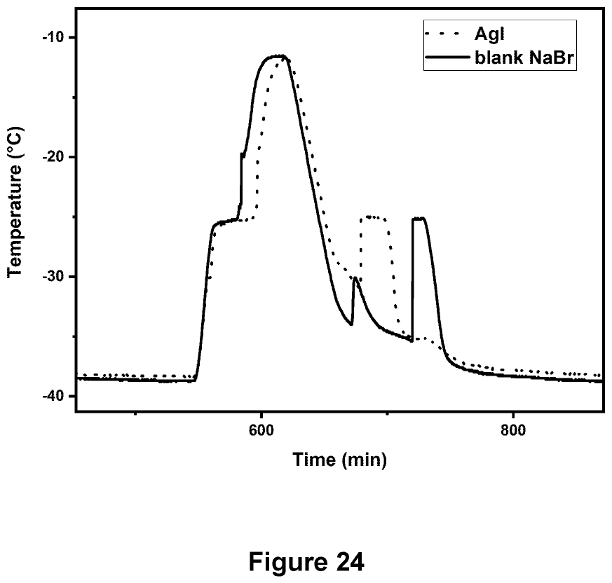

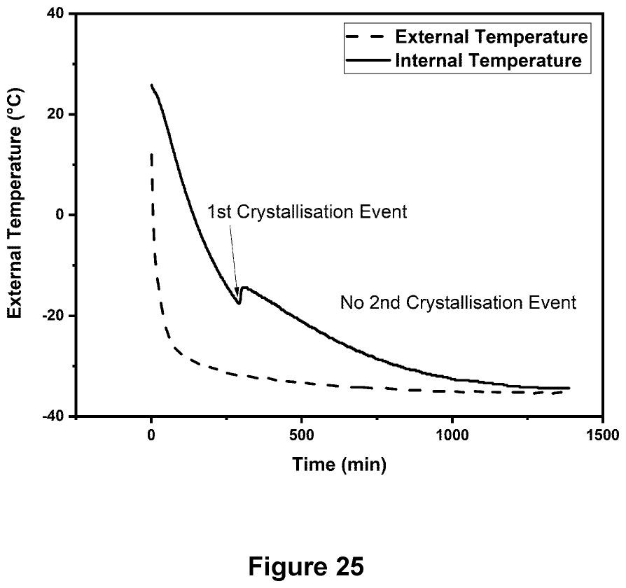

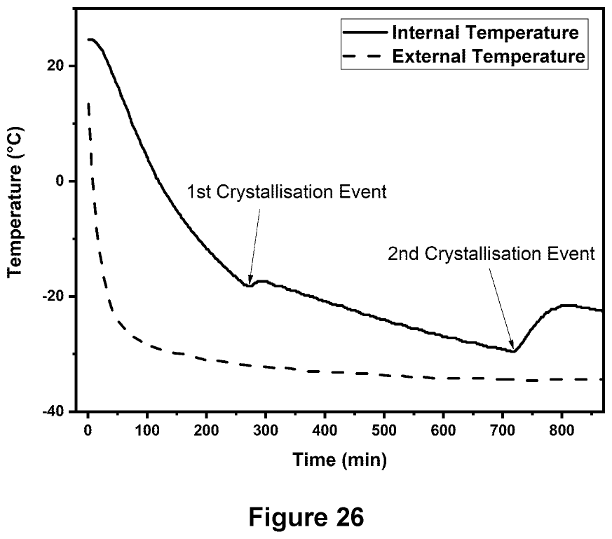

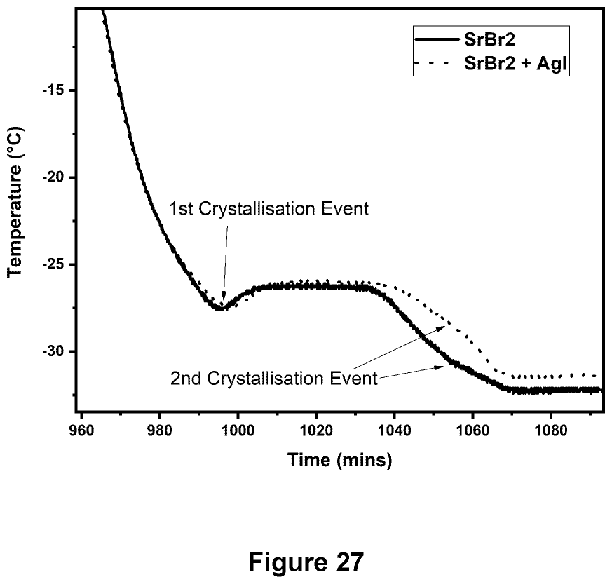

By way of further non-limiting example, a PCM comprised of sodium bromide, water and one or more nucleation agents are considered. It has been found by the inventors that aluminium oxide, silica and calcium carbonate may be used as a nucleation agent to trigger the first crystallisation event (FIGS. 21, 22 and 23). On testing silver iodide as a nucleator it was also found that it acts as a nucleation agent for the first crystallisation event of a PCM comprised of sodium bromide and water (FIG. 24). This is at odds with what is known to the inventors for other PCMs such as carboxylates (FIGS. 25 & 26) and 2+ metal halides (FIG. 27). As shown in FIG. 25, without any silver iodide nucleation agent, a sodium acetate salt-water eutectic PCM will undergo its first crystallisation event but not the second, but if silver iodide is added to the system both crystallisation events occur as shown in FIG. 26. Similarly, the 2+ halide salt strontium bromide-water eutectic exhibits increased subcooling in its second crystallisation event when silver iodide is absent from the PCM than when it is present, however the first crystallisation event is unaffected by the change (FIG. 27).

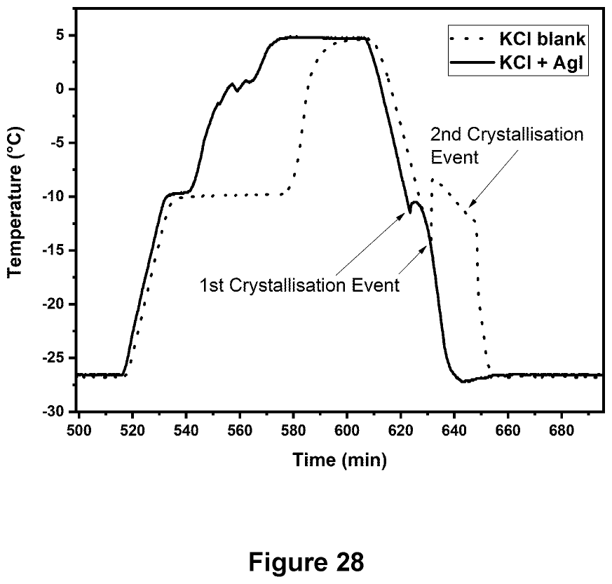

Further testing was carried out on other 1+ cation halides, such as the KCl-water and NH₄Cl-water eutectic, and it was found that silver iodide would act as a nucleation agent for the first crystallisation event. FIG. 28 shows a comparison of a salt-water eutectic PCM where the salt is KCl, with and without a Agl nucleation agent. There is a noticeable rise in the first crystallisation event, in the same manner as is noted for other 1+ halide salt-water eutectics when Agl is present in the material, but no indication of a second crystallisation event. It appears that the presence of Agl in fact hinders the second crystallisation event in this example, as the blank, which exhibits significant subcooling in the first crystallisation event, does undergo both transitions, and therefore has a longer melting transition and no sign of any melting transition around 0° C. Conversely the sample with Agl exhibits little subcooling on the first crystallisation event but no second crystallisation event, and therefore has a short melting transition (i.e. little energy stored). Thus, for a PCM of this type to be used, a combination of nucleation agents that act on the first and second crystallisation event could be used (i.e. Agl, vermiculite and/or silicon carbide). The NH₄Cl-water eutectic responds in a similar manner to Agl as shown in FIG. 29, with neither the blank or the material prepared containing Agl exhibiting a second crystallisation event and thus a relatively short, broad melting transition.

In summation, Table 1 discloses nucleation agents which tend to, but do not in every case, act to reduce subcooling on their first and second crystallisation events.

TABLE 1

| Nucleation agent(s) for the | Nucleation agent(s) for the |
|---|---|
| first crystallization event | second crystallization event |
| (one or more of the following | (one or more of the following |
| nucleation agent(s) | nucleation agent(s)) |
| Calcium carbonate | Silicon Carbide |
| Silicon dioxide | Phyllosilicate materials |
| | (e.g. vermiculite) |
| Aluminium oxide | Silver iodide |
| Iron oxide | |

More specifically, Table 2 shows the types of salts, in accordance with the present invention, used in sub-zero salt-water eutectic PCMs with nucleation agents which act on the first and second crystallisation event.

TABLE 2

| | Nucleation agent(s) for the | Nucleation agent(s) for the |
|---|---|---|
| | first crystallization event | second crystallization event |
| | (one or more of the following | (one ormore of the following |
| Type of salt | nucleation agent(s)) | nucleation agent(s)) |
| 1+ halides (incl. NH₄)_{—} | Calcium carbonate | Silicon Carbide |
| | Silicon dioxide | Phyllosilicate materials |
| | Aluminium oxide | (e.g. vermiculite) |
| | Iron oxide | |
| | Silver lodide | |
| 2+ halides | Calcium carbonate | Silicon Carbide |
| | Silicon dioxide | Vermiculite |
| | Aluminium oxide | Silver iodide |
| | Iron oxide | |
| | Titanium dioxide | |
| Sulfates | Silicon dioxide | Silicon Carbide |
| | Aluminium oxide | Calcium carbonate |
| | Iron oxide | |
| | Titanium dioxide | |
| Nitrates | Calcium carbonate | Silicon Carbide |
| | Silicon dioxide | Vermiculite |
| | Aluminium oxide | Silver iodide |
| | Iron oxide | |
| | Titanium dioxide | |
| Carboxylates | Calcium carbonate | Silicon Carbide |
| | Silicon dioxide | Vermiculite |
| | Aluminium oxide | Silver iodide |
| | Iron oxide | Titanium dioxide |

The types of salts defined in Table 1 and 2 are representative of the preferred nucleating agent(s). Further, more specific, detail is given in Tables 3 and 4.

Table 3 discloses preferred embodiments of the present invention.

TABLE 3

| | Nucleation agent(s) for the | Nucleation agent(s) for the |
|---|---|---|
| Salt used in the salt- | first crystallization event | second crystallization event |
| water eutectic PCM | (one ormore of the following | (one ormore of the following |
| (or hydrate form thereof) | nucleation agent(s)) | nucleation agent(s)) |
| Magnesium nitrate | Silicon dioxide | Silicon carbide, |
| | Titanium dioxide, | Silver iodide |
| | aluminium oxide, | Vermiculite |
| | iron oxide, | |
| | calcium carbonate | |
| Magnesium sulfate | Aluminium oxide | Silicon carbide, |
| | Silicon dioxide | Calcium carbonate |
| | Titanium dioxide, | Vermiculite |
| | aluminium oxide, | |
| | iron oxide, | |
| | silver iodide | |
| Magnesium chloride | Aluminium oxide | Silicon carbide, |
| | Silicon dioxide | Silver iodide |
| | Titanium dioxide, | |
| | aluminium oxide, | |
| | iron oxide | |
| Sodium acetate | Calcium carbonate, | Silver iodide |
| | Silicon dioxide, | Silicon carbide |
| | Iron oxide | Titanium dioxide |
| Sodium formate | Calcium carbonate | Silver iodide |
| | Silicon dioxide | Silicon carbide |
| | | Titanium dioxide |
| | | Vermiculite |
| Sodium sulfate | Aluminium oxide | Silicon carbide, |
| | Silicon dioxide, | Calcium carbonate |
| | iron oxide, | |
| | Silver iodide | |
| Sodium chloride | Aluminium oxide, | Titanium dioxide |
| | Calcium carbonate | Vermiculite |
| | Silicon dioxide | Silicon Carbide |
| | Silver lodide | |
| Sodium bromide | Calcium carbonate, | Silicon Carbide |
| | Aluminium oxide | Silver iodide |
| | Silicon dioxide | |
| Sodium propionate | Calcium carbonate, | Silver iodide |
| | Silicon dioxide, | Silicon carbide |
| | | Titanium dioxide |
| Sodium 2,2′- | Calcium carbonate, | Silver iodide |
| bishydroxypropionate | Silicon dioxide, | Silicon carbide |
| | | Titanium dioxide |
| Sodium glycolate | Calcium carbonate, | Silver iodide |
| | Silicon dioxide, | Silicon carbide |
| | | Titanium dioxide |
| Sodium glycinate | Calcium carbonate, | Silver iodide |
| | Silicon dioxide, | Silicon carbide |
| | | Titanium dioxide |
| Sodium glutamate | Calcium carbonate, | Silver iodide |
| | Silicon dioxide, | Silicon carbide |
| | | Titanium dioxide |
| Sodium aspartate | Calcium carbonate, | Silver iodide |
| | Silicon dioxide, | Silicon carbide |
| | | Titanium dioxide |
| Sodium alaninate | Calcium carbonate, | Silver iodide |
| | Silicon dioxide, | Silicon carbide |
| | | Titanium dioxide |
| Disodium adipate | Calcium carbonate, | Silver iodide |
| | Silicon dioxide, | Silicon carbide |
| | | Titanium dioxide |
| Potassium chloride | Aluminium oxide | Silicon Carbide |
| | Calcium carbonate | Vermiculite |
| | Titanium dioxide | |
| | Silver iodide | |
| Potassium acetate | Calcium carbonate, | Silver iodide |
| | Silicon dioxide, | Silicon carbide |
| | Titanium dioxide | Titanium dioxide |
| | | Vermiculite |
| Potassium glycinate | Calcium carbonate, | Silver iodide |
| | Silicon dioxide, | Silicon carbide |
| | Titanium dioxide | Titanium dioxide |
| | | Vermiculite |
| Potassium alaninate | Calcium carbonate, | Silver iodide |
| | Silicon dioxide, | Silicon carbide |
| | Titanium dioxide | Titanium dioxide |
| | | Vermiculite |
| Dipotassium adipate | Calcium carbonate, | Silver iodide |
| | Silicon dioxide, | Silicon carbide |
| | Titanium dioxide | Titanium dioxide |
| | | Vermiculite |
| Ammonium chloride | Calcium carbonate | Silicon carbide |
| | Aluminium oxide | Vermiculite |
| | Silver iodide | |
| | Titanium dioxide | |
| Lithium sulfate | Iron oxide | Silicon carbide |
| | Titanium dioxide | Calcium carbonate |
| | Aluminium oxide | Vermiculite |
| Lithium nitrate | Iron oxide | Silicon carbide |
| | Aluminium oxide | Titanium dioxide |
| | | Silicon dioxide |
| | | Vermiculite |
| Strontium chloride | Calcium carbonate | Silver lodide |
| | Aluminium oxide | Silicon carbide |
| | Silicon dioxide | Vermiculite |
| | Titanium dioxide, | |
| | iron oxide | |
| Strontium bromide | Calcium carbonate | Silver lodide |
| | Aluminium oxide | Silicon carbide |
| | Silicon dioxide | Vermiculite |
| | Titanium dioxide, | |
| | iron oxide | |

Table 4 shows more specific further preferred embodiments of the present invention.

| | | Nucleation agent(s) | Nucleation agent(s) |
|---|---|---|---|
| | | for the first | for the second |
| | Melting | crystallization event | crystallization event |
| PCM Salt Identity | Transition | (one ormore of the | (one or more of the |
| and Concentration | Temperature | following nucleation | following nucleation |
| (approx. % in water) | (approx. ° C.) | agent(s)) (>0.01 wt. %) | agent(s)) (>0.01 wt. %) |
| Sodium sulfate (3.5 wt. %) | −1 | Silver iodide | Silicon carbide |
| Sodium potassium | −4 | Calcium carbonate | Silicon carbide |
| tartrate (5 wt. %) | | | |
| Magnesium | −5 | Aluminium oxide | Silicon carbide |
| sulfate (19 wt. %) | | Silver iodide | Calcium carbonate |
| KCl (19.5 wt. %) | −10 | Titanium dioxide | Vermiculite |
| | | Aluminium oxide | |
| | | Silver iodide | |
| | | Calcium carbonate | |
| NH₄Cl (18.6 wt. %) | −14 | Silver iodide | Vermiculite |
| | | Aluminium oxide | Silicon carbide |
| | | Calcium carbonate | |
| NaOOCH (24.0 wt. %) | −15 | Calcium carbonate | Vermiculite |
| | | | Silicon carbide |
| | | | Silver iodide |
| SrCl₂ (19.5 wt. %) | −16 | Aluminium oxide | Silver iodide |
| | | | Silicon carbide |
| | | | Vermiculite |
| NaNO3 (35 wt. %) | −17 | Calcium carbonate | Silver iodide |
| | | Iron oxide | Silicon carbide |
| | | Silicon dioxide | Vermiculite |
| | | | Aluminium oxide |
| NaOAc (22.7 wt. %) | −15 | Iron oxide | Silicon carbide |
| NaOAc (27.0 wt. %) | −18 | Calcium carbonate | Silver iodide |
| | | Silicon dioxide | |
| NaCl (22.4 wt. %) | −21 | Calcium carbonate | Vermiculite |
| | | Aluminium oxide | Silicon carbide |
| | | | Titanium dioxide |
| LiNO₃ (24.5 wt. %) | −22 | Iron oxide | Silicon carbide |
| | | | Titanium dioxide |
| | | | Silicon dioxide |
| NaBr (39 wt. %) | −25 | Calcium carbonate | Silicon carbide |
| | | Aluminium oxide | |
| | | Silver lodide | |
| SrBr₂ (41 wt. %) | −26 | Calcium carbonate | Silver iodide |
| Mg(NO3)₂ (29.9 wt. %) | −30 | Silicon dioxide | Silicon carbide |
| | | Aluminium oxide | |

Table 5 details various nucleation agents and the salts and concentrations with which they may be used.

| | | Minimum | Preferred |
|---|---|---|---|
| Salts (one or | Nucleation | loading | loading |
| morethereof in water) | Agent(s) | (wt. %) | (wt. %) |
| Magnesium nitrate | Calcium | 0.1 | 1.0 |
| Magnesium sulfate | carbonate | | |
| Ammonium chloride | | | |
| Sodium potassium tartrate | | | |
| Sodium formate | | | |
| Sodium nitrate | | | |
| Sodium acetate | | | |
| Sodium chloride | | | |
| Sodium bromide | | | |
| Strontium bromide | | | |
| Magnesium sulfate | Aluminium | 0.01 | 0.5 |
| Potassium chloride | oxide | | |
| Ammonium chloride | | | |
| Strontium chloride | | | |
| Sodium nitrate | | | |
| Sodium chloride | | | |
| Sodium bromide | | | |
| Magnesium nitrate | | | |
| Sodium acetate | Silicon | 0.01 | 0.5 |
| Lithium nitrate | oxide | | |
| Magnesium nitrate | | | |
| Sodium sulfate | Silicon | 0.01 | 0.5 |
| Sodium potassium tartrate | carbide | | |
| Magnesium sulfate | | | |
| Ammonium chloride | | | |
| Sodium formate | | | |
| Strontium chloride | | | |
| Sodium nitrate | | | |
| Sodium acetate | | | |
| Sodium chloride | | | |
| Lithium nitrate | | | |
| Sodium bromide | | | |
| Magnesium nitrate | | | |
| Sodium sulfate | Silver | 0.01 | 0.5 |
| Magnesium sulfate | iodide | | |
| Potassium chloride | | | |
| Ammonium chloride | | | |
| Sodium bromide | | | |
| Strontium bromide | | | |
| Strontium chloride | | | |
| Sodium nitrate | Iron | 0.01 | 0.5 |
| Sodium acetate | oxide | | |
| Lithium nitrate | | | |
| Potassium chloride | Vermiculite | 0.01 | 0.5 |
| Ammonium chloride | | | |
| Sodium formate | | | |
| Strontium chloride | | | |
| Sodium nitrate | | | |
| Sodium chloride | | | |
| Lithium nitrate | | | |
| Magnesium sulfate | Titanium | 0.01 | 0.5 |
| Potassium chloride | dioxide | | |
| Sodium chloride | | | |
| Lithium nitrate | | | |

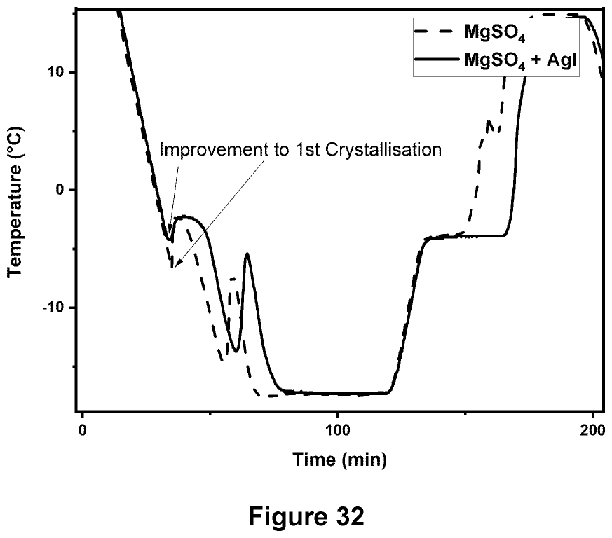

Further specific embodiments of the present invention are further exemplified in FIGS. 32-69.

FIG. 32 shows the use of Agl to improve the first crystallisation event of a PCM comprising a magnesium sulfate-water eutectic (i.e. approx. 19 wt. % MgSO₄ in water).

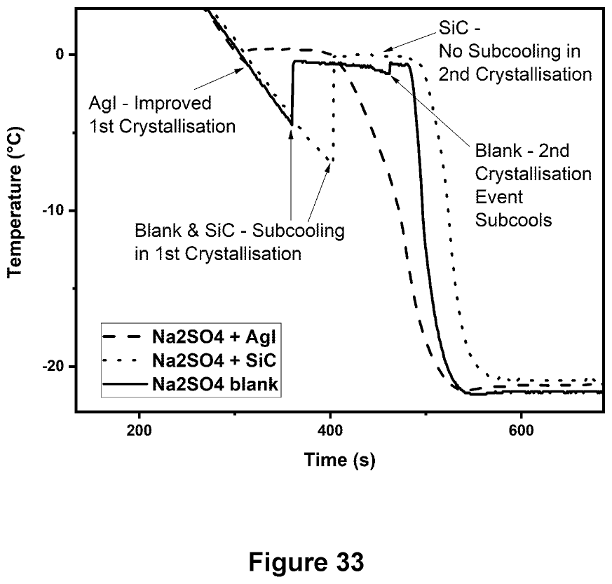

FIG. 33 shows a further sulfate salt water eutectic, the sodium sulfate water eutectic (i.e. approx. 3.5 wt. % Na₂SO₄ in water) having improved nucleation of the 1^{st} and 2^{nd} crystallisation events by the addition of Agl and SiC respectively against a blank.

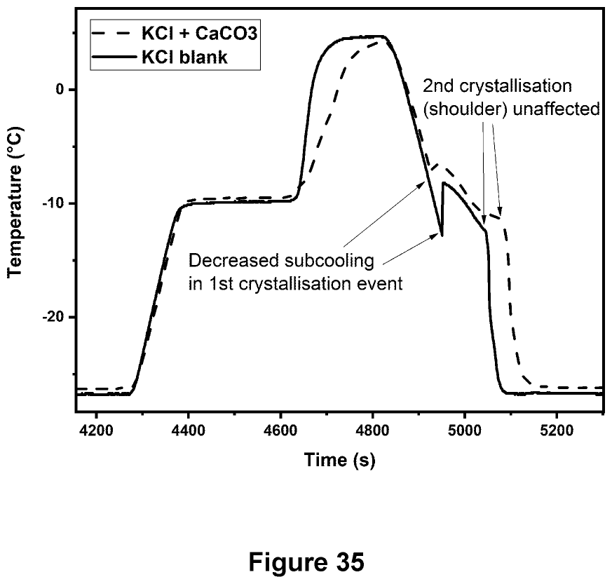

FIG. 35 shows calcium carbonate increasing the temperature of the first crystallisation event of a PCM comprising a eutectic of KCl and water (i.e. approx. 19.5 wt. % KCl in water).

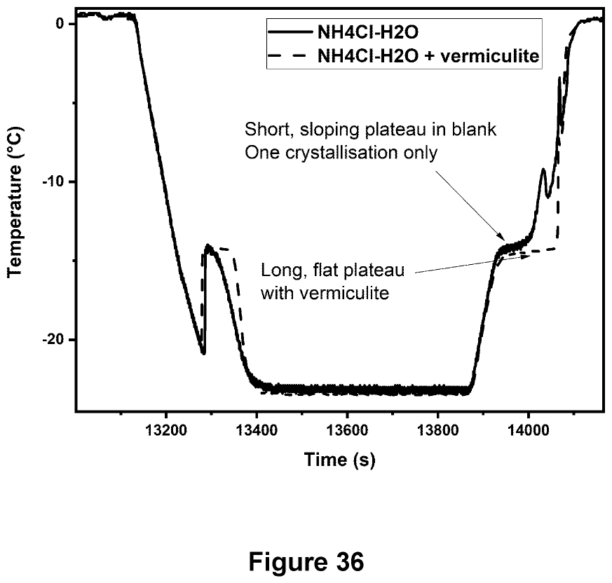

FIG. 36 shows that the presence of vermiculite induces the second crystallisation event in a eutectic of NH₄Cl and water (i.e. approx. 18.6 wt. % NH₄Cl in water), whereas the blank containing no vermiculite is shown to only go through one crystallisation event and therefore exhibits a short melting transition across a wide temperature range compared to the sample comprising vermiculite.

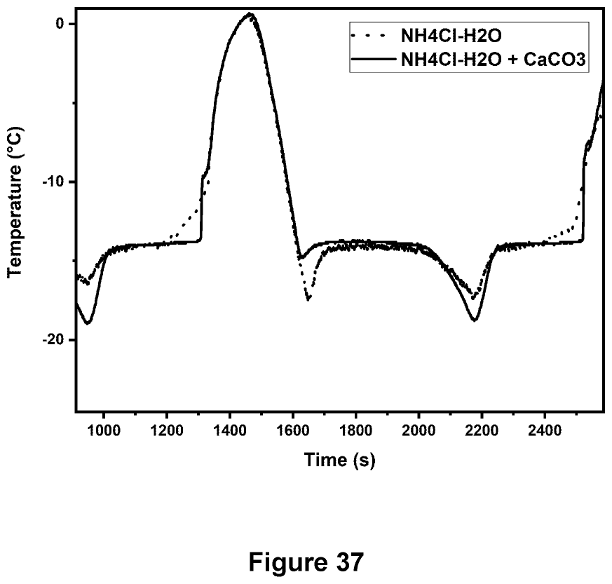

FIG. 37 shows that the presence of calcium carbonate improving the crystallisation of the first crystallisation event of a eutectic of NH₄Cl and water (i.e. approx. 18.6 wt. % NH₄Cl in water).

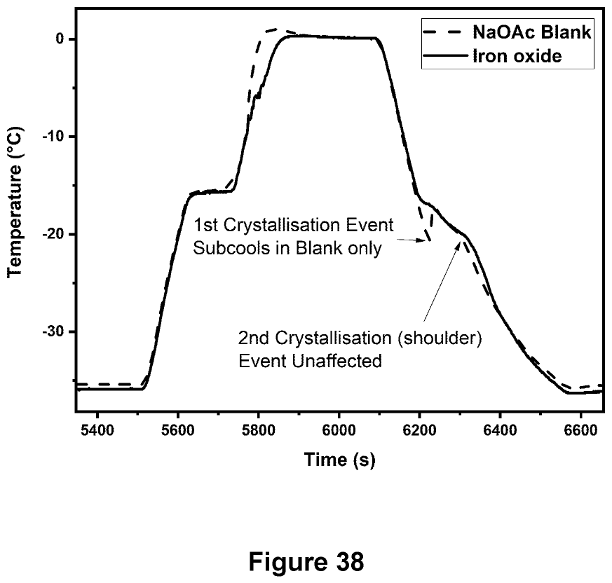

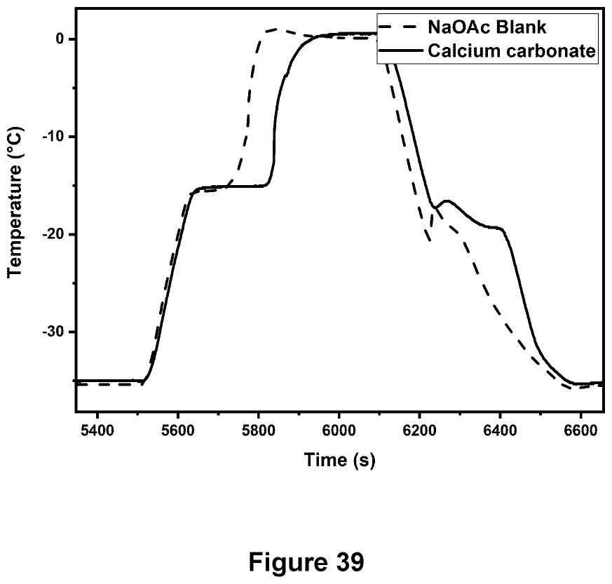

FIG. 38 shows that iron oxide improves the nucleation of the first nucleation event of a eutectic of sodium acetate and water (i.e. approx. 22.7 wt. % NaOAc in water). This effect is also noted when calcium carbonate (FIG. 39).

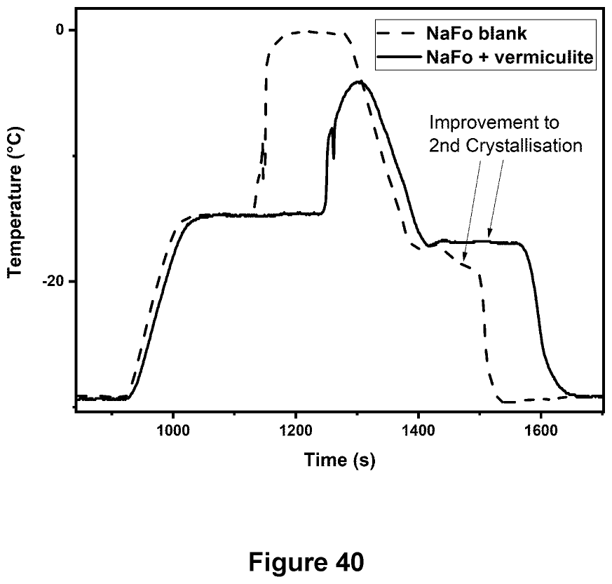

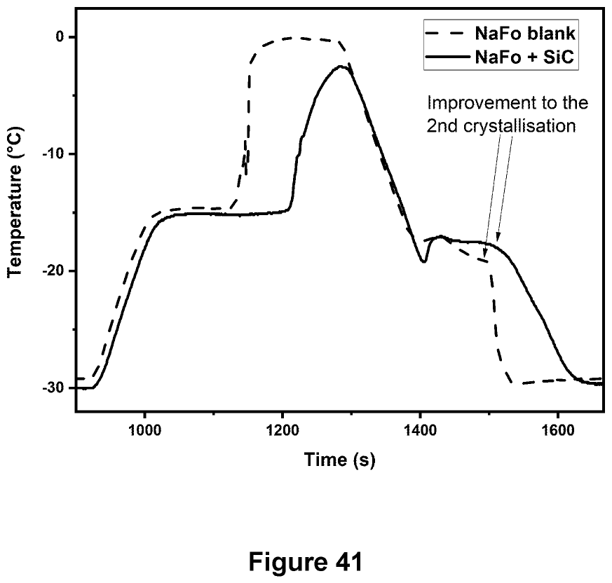

FIG. 40 shows the improvement of the second crystallisation event of a eutectic of sodium formate and water (i.e. approx. 24.0 wt. % sodium formate—abbreviated NaFo—in water) due to the presence of vermiculite. FIG. 41 shows a similar improvement to the second crystallisation event when using silicon carbide as a nucleation agent.

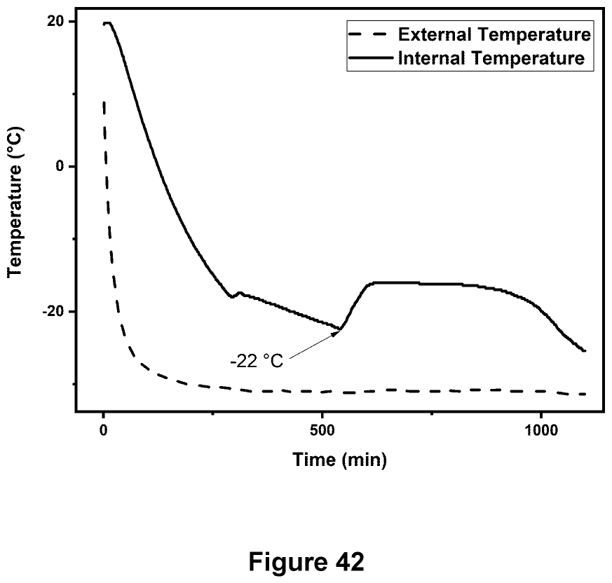

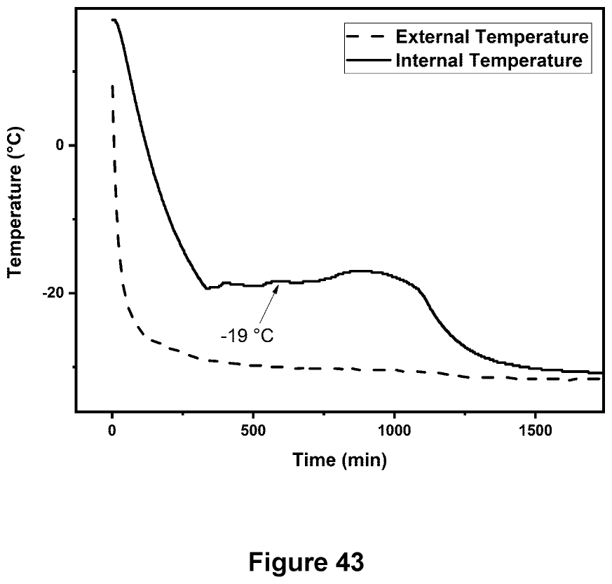

FIG. 42 shows the freezing process of a PCM comprising a sodium formate-water eutectic (approx. 24.0 wt. % sodium formate in water) without any nucleation agent. Two crystallisation events can be observed, with the second occurring at around −22° C. FIG. 43 shows the improvement of this crystallisation event for this PCM when silver iodide is present, with nucleation now occurring at about −19° C.

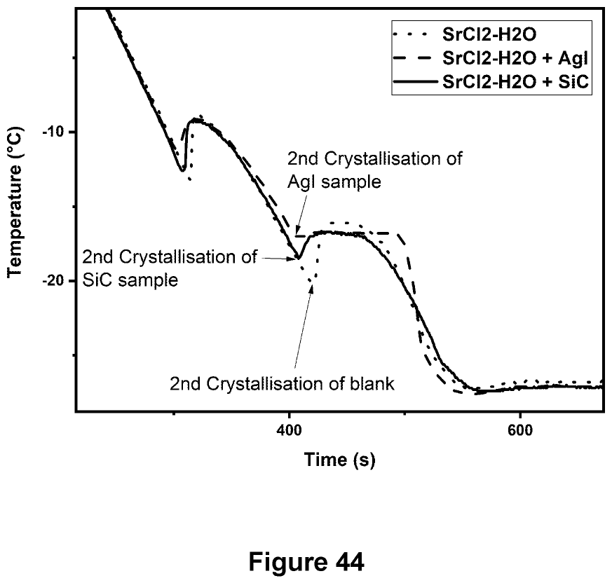

FIG. 44 shows improvements to the second crystallisation event of a PCM comprising a strontium chloride-water eutectic (approx. 19.5 wt. % SrCl₂ in water) in the presence of silicon carbide and silver iodide.

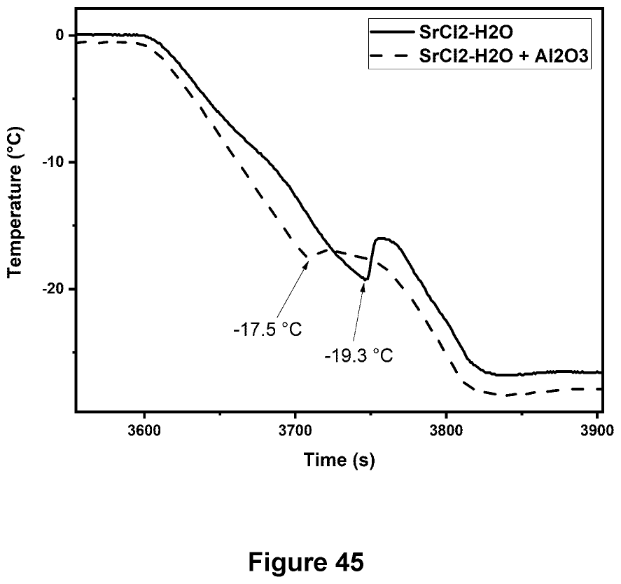

FIG. 45 shows improvements to the first crystallisation event of a PCM comprising a strontium chloride-water eutectic (approx. 19.5 wt. % SrCl₂ in water) in the presence of aluminium oxide.

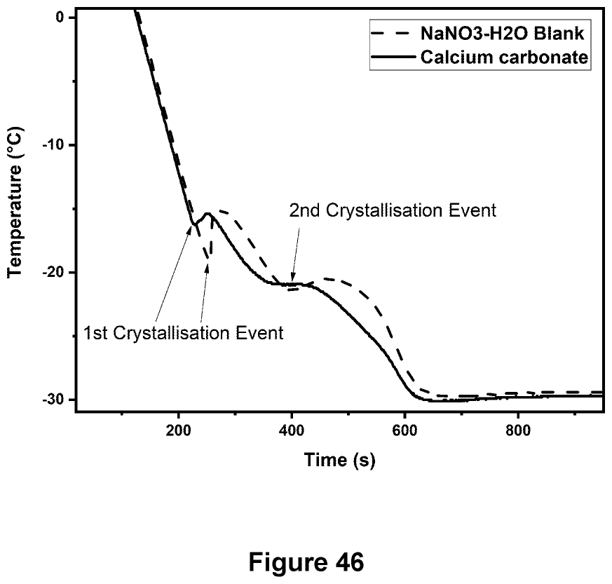

FIG. 46 shows improvements to the first crystallisation event of a PCM comprising a sodium nitrate-water eutectic (approx. 35.0 wt. % NaNO₃ in water) in the presence of calcium carbonate.

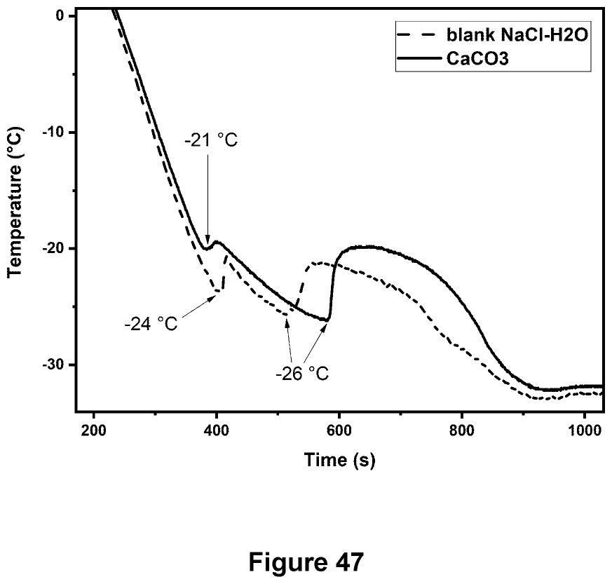

FIG. 47 shows improvements to the first crystallisation event of a PCM comprising a sodium chloride-water eutectic (approx. 22.4 wt. % NaCl in water) in the presence of calcium carbonate.

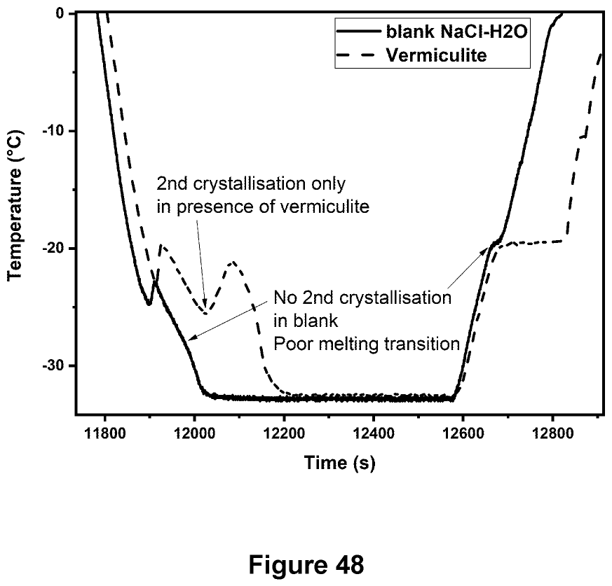

FIG. 48 shows that the second crystallisation event of a PCM comprising a sodium chloride-water eutectic (approx. 22.4 wt. % NaCl in water) may not occur on cooling, giving a poor melting transition on warming to its phase transition temperature (about −21° C.). However the second crystallisation event may be triggered in the presence of vermiculite.

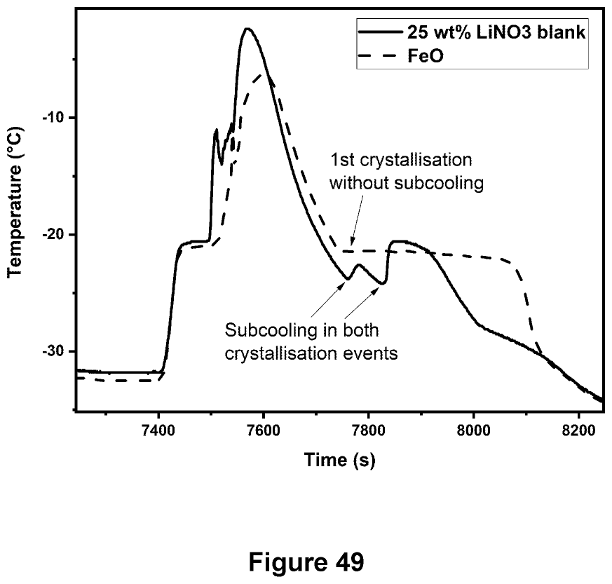

FIG. 49 shows improvements to the first crystallisation event of a PCM comprising a lithium nitrate-water eutectic (approx. 24.5 wt. % LiNO₃ in water) in the presence of iron oxide.

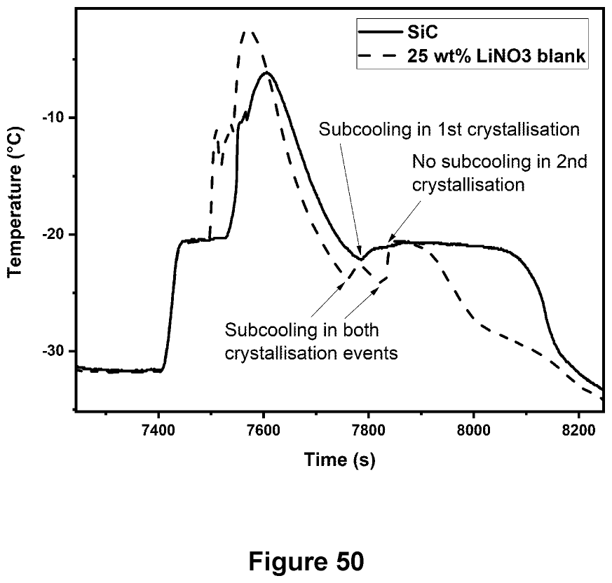

FIG. 50 shows improvements to the second crystallisation event of a PCM comprising a lithium nitrate-water eutectic (approx. 24.5 wt. % LiNO₃ in water) in the presence of silicon carbide.

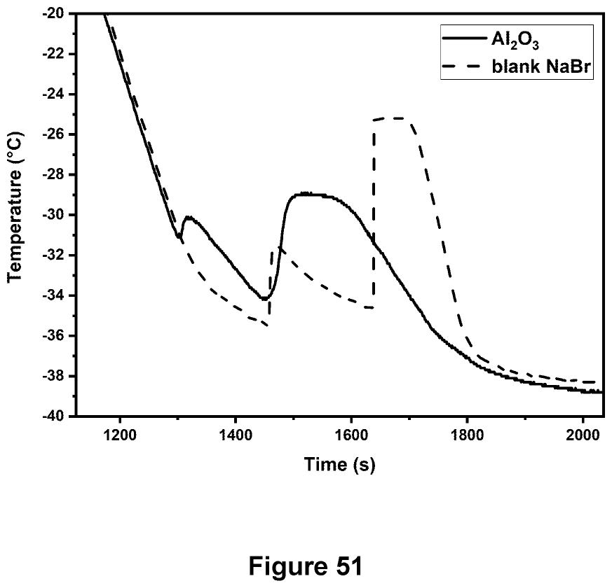

FIG. 51 shows improvements to the first crystallisation event of a PCM comprising a sodium bromide-water eutectic (approx. 39 wt. % NaBr in water) in the presence of alumina.

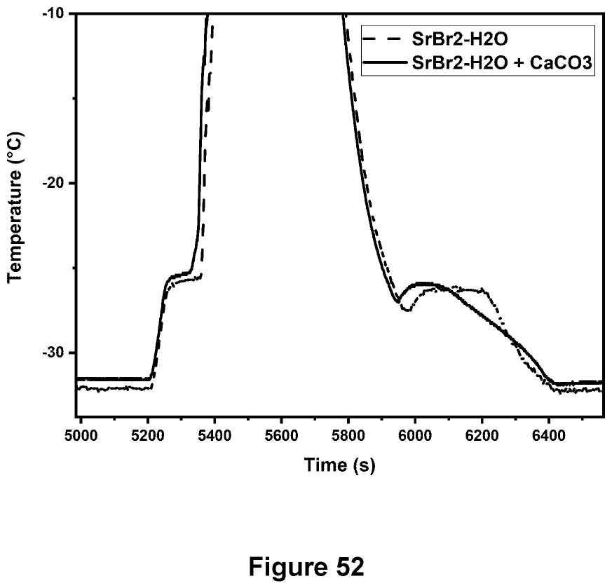

FIG. 52 shows improvements to the first crystallisation event of a PCM comprising a strontium bromide-water eutectic (approx. 41 wt. % SrBr₂ in water) in the presence of calcium carbonate.

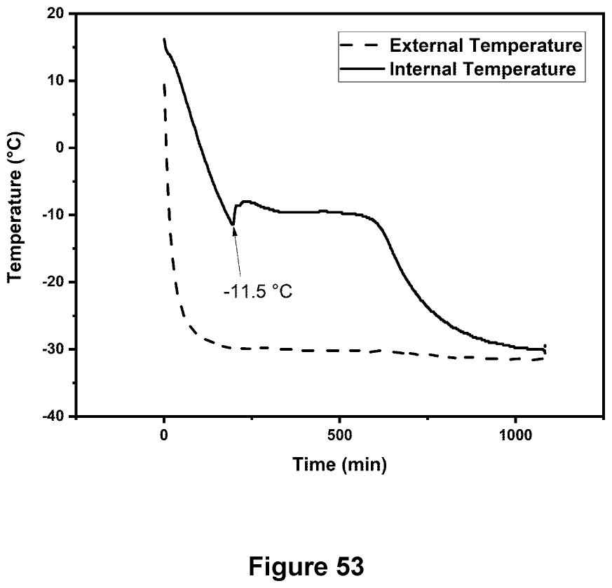

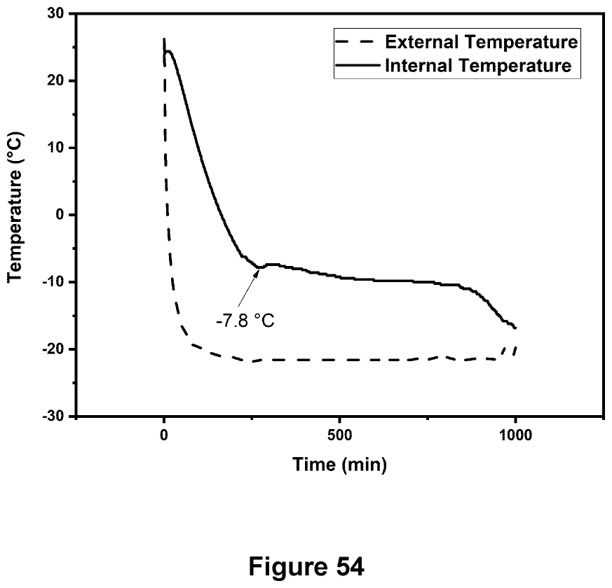

FIGS. 53 and 54 show the freezing profile of a eutectic comprised of rochelle's salt (potassium sodium tartrate) in water (approx. 5 wt. % rochelle's salt in water). The blank (FIG. 53) shows subcooling of the first crystallisation event to about −11.5° C., whereas the sample with calcium carbonate (FIG. 54) has the first crystallisation event at around −7.8° C. In both cases the second crystallisation event occurs as a plateau around −9.8° C. and are thus unaffected by the presence of calcium carbonate.

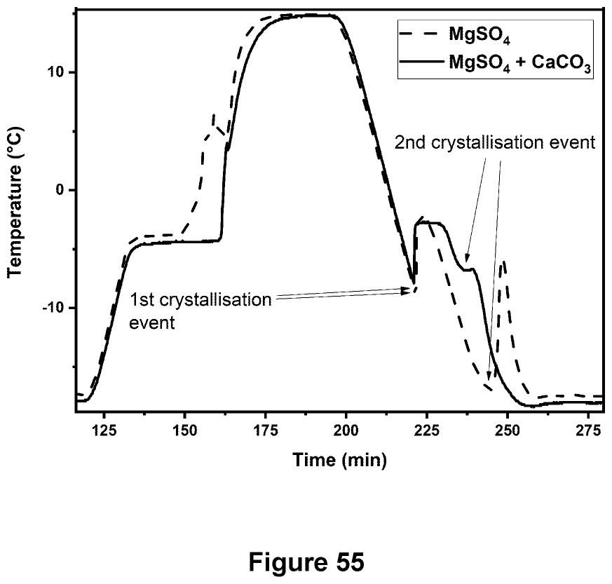

FIG. 55 shows improvements to the second crystallisation event of a PCM comprising a magnesium sulfate-water eutectic (approx. 19 wt. % MgSO₄ in water) in the presence of calcium carbonate.

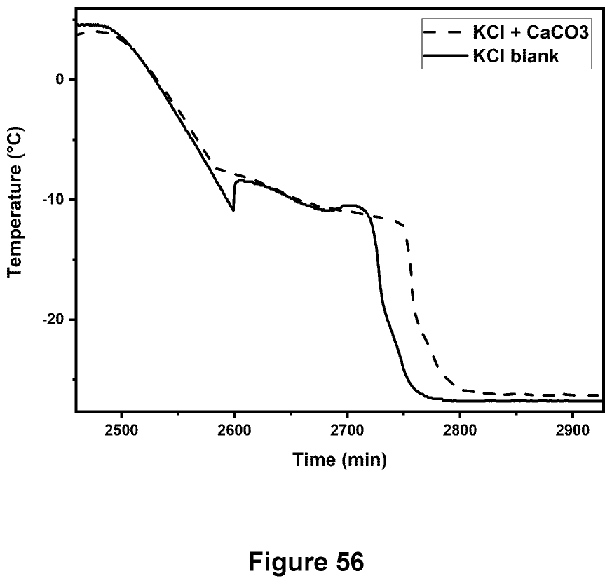

FIG. 56 shows improvements to the first crystallisation event of a PCM comprising a potassium chloride-water eutectic (approx. 19.5 wt. % KCl in water) in the presence of calcium carbonate.

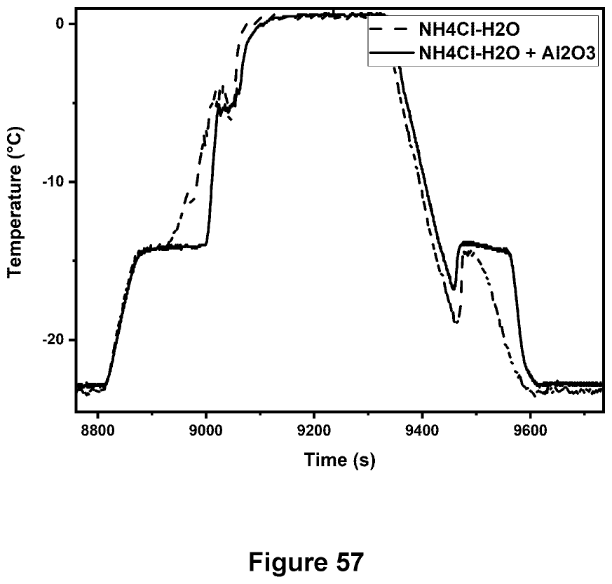

FIG. 57 shows improvements to the first crystallisation event of a PCM comprising an ammonium chloride-water eutectic (approx. 18.6 wt. % NH₄Cl in water) in the presence of aluminium oxide.

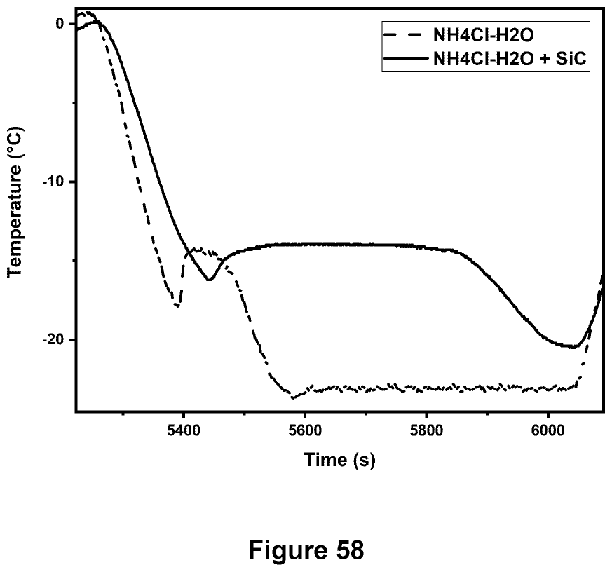

FIG. 58 shows improvements to the second crystallisation event of a PCM comprising an ammonium chloride-water eutectic (approx. 18.6 wt. % NH₄Cl in water) in the presence of silicon carbide.

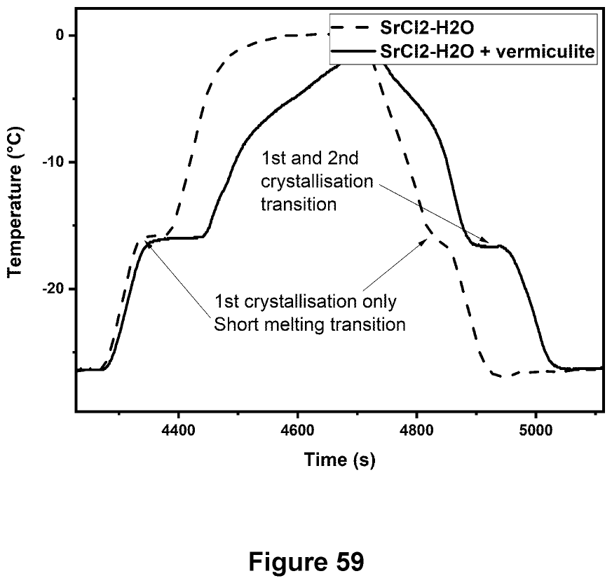

FIG. 59 shows improvements to the second crystallisation event of a PCM comprising a strontium chloride-water eutectic (approx. 19.5 wt. % SrCl₂ in water) in the presence of vermiculite. The blank comparison sample exhibits a shorter melting transition, indicating only partial crystallisation (i.e. only the first crystallisation event has taken place). By comparison, the sample comprising vermiculite exhibits a long, flat melting transition (i.e. has high energy) and therefore has undergone both crystallisation events.

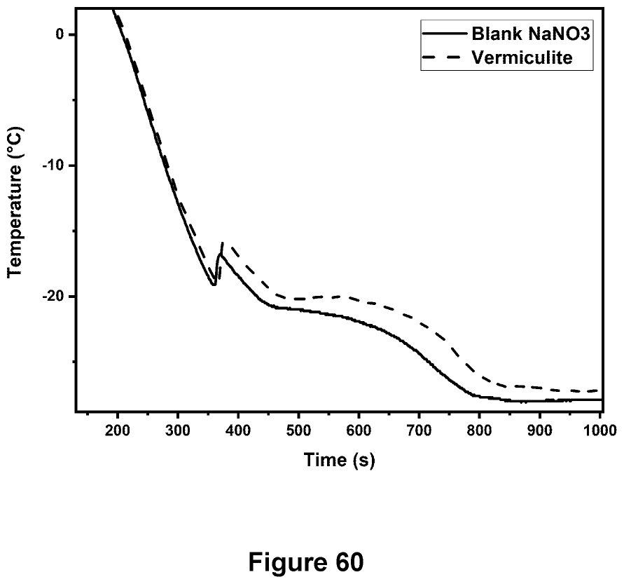

FIG. 60 shows improvements to the second crystallisation event of a PCM comprising a sodium nitrate-water eutectic (approx. 35 wt. % NaNO₃ in water) in the presence of vermiculite.

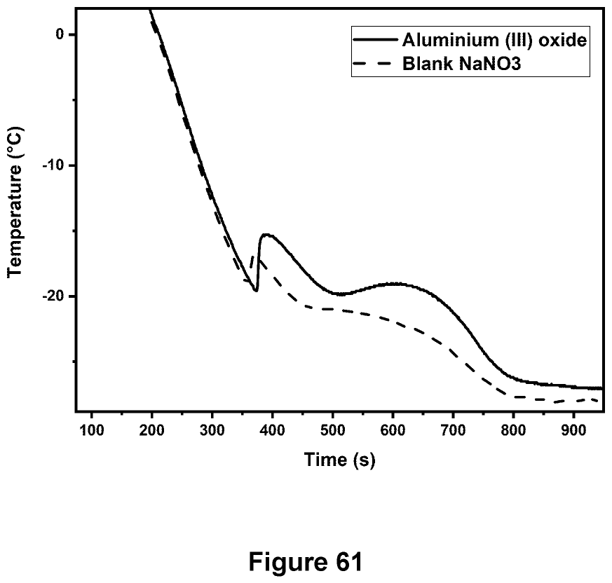

FIG. 61 shows improvements to the second crystallisation event of a PCM comprising a sodium nitrate-water eutectic (approx. 35 wt. % NaNO₃ in water) in the presence of aluminium oxide.

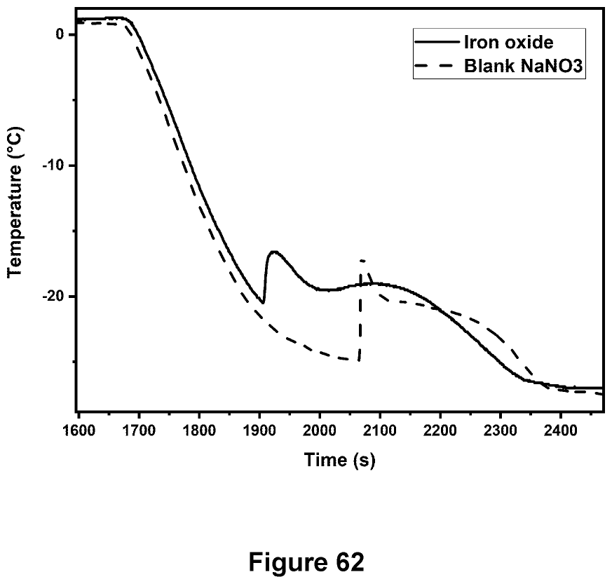

FIG. 62 shows improvements to the first crystallisation event of a PCM comprising a sodium nitrate-water eutectic (approx. 35 wt. % NaNO₃ in water) in the presence of iron oxide.

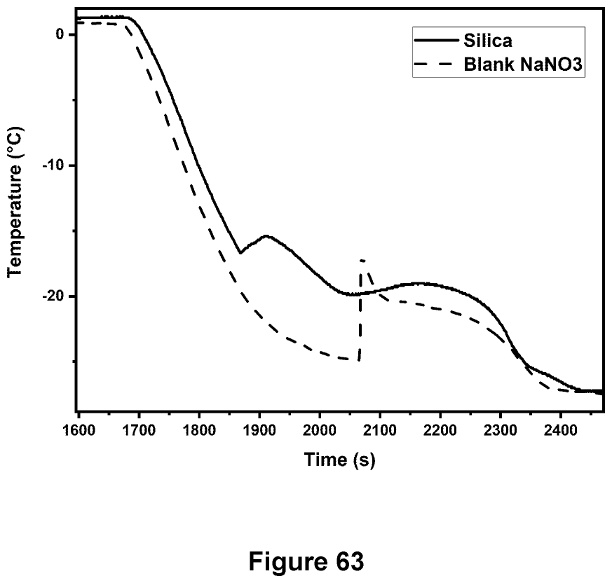

FIG. 63 shows improvements to the first crystallisation event of a PCM comprising a sodium nitrate-water eutectic (approx. 35 wt. % NaNO₃ in water) in the presence of silicon oxide.

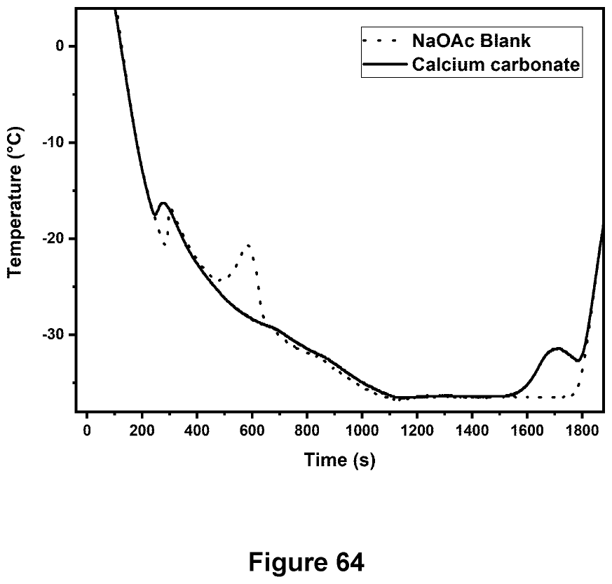

FIG. 64 shows improvements to the first crystallisation event of a PCM comprising a sodium acetate-water eutectic (approx. 27.0 wt. % NaOAc in water) in the presence of calcium carbonate.

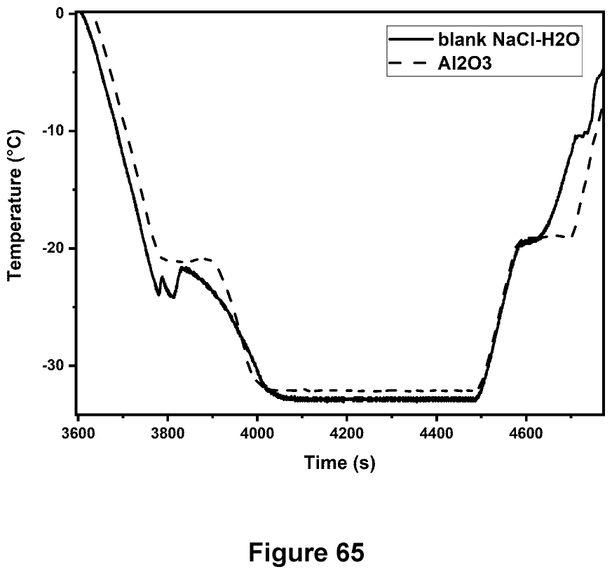

FIG. 65 shows improvements to the first crystallisation event of a PCM comprising a sodium chloride-water eutectic (approx. 22.4 wt. % NaCl in water) in the presence of aluminium oxide.

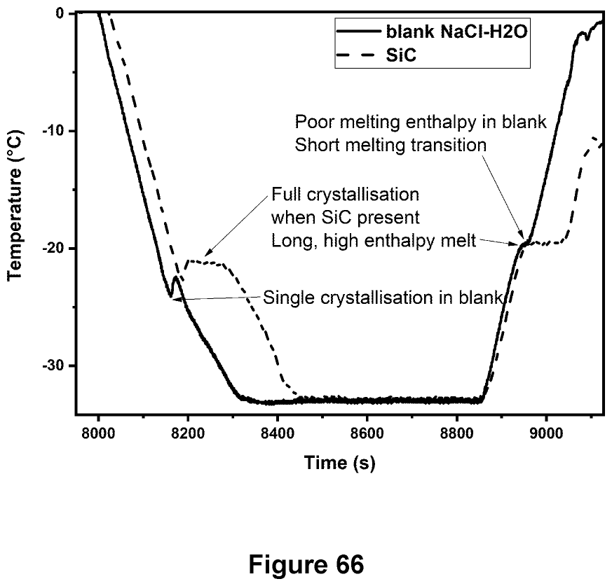

FIG. 66 shows improvements to the second crystallisation event of a PCM comprising a sodium chloride-water eutectic (approx. 22.4 wt. % NaCl in water) in the presence of silicon carbide. A longer melting transition on melting is indicative of full crystallisation, which is not present in the blank but can be observed in the sample comprising silicon carbide.

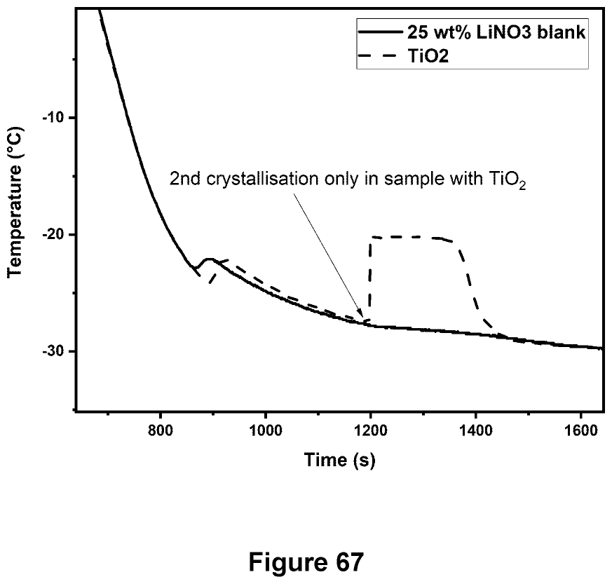

FIG. 67 shows TiO₂ triggering the second crystallisation event in a PCM comprising a lithium nitrate-water eutectic (approx. 24.5 wt. % LiNO₃ in water). The blank sample was found to exhibit subcooling of the second crystallisation event below the minimum temperature used during thermal cycling.

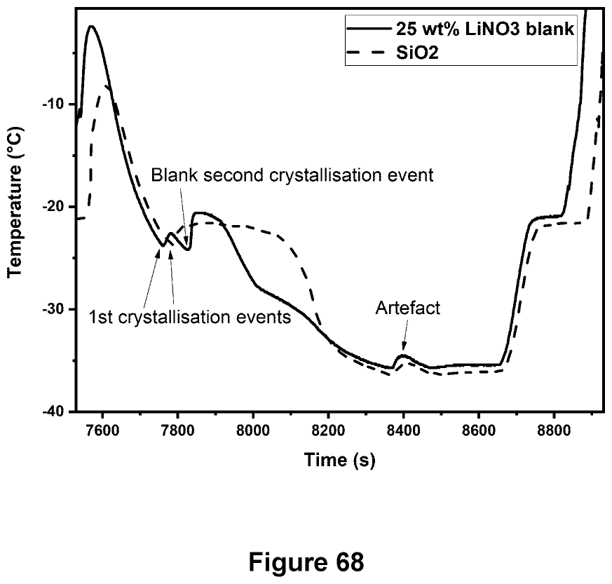

FIG. 68 shows SiO₂ improving the second crystallisation event of a PCM comprising a lithium nitrate-water eutectic (approx. 24.5 wt. % LiNO₃ in water). The anomaly denoted artefact is due to a nearby sample warming on crystallisation and is not due to the samples described in the figure. Here it can be observed that improvements to the second crystallisation event of the PCM caused by the inclusion of SiO₂ cause the two crystallisation events to be indistinguishable from one another, i.e. no subcooling is observed in the second after the first has occurred/is occurring. However full crystallisation (both first and second crystallisation events) can be demonstrated to have occurred as the melting transition is observable, flat, and long in duration. These features are only observed in samples that have undergone full crystallisation.

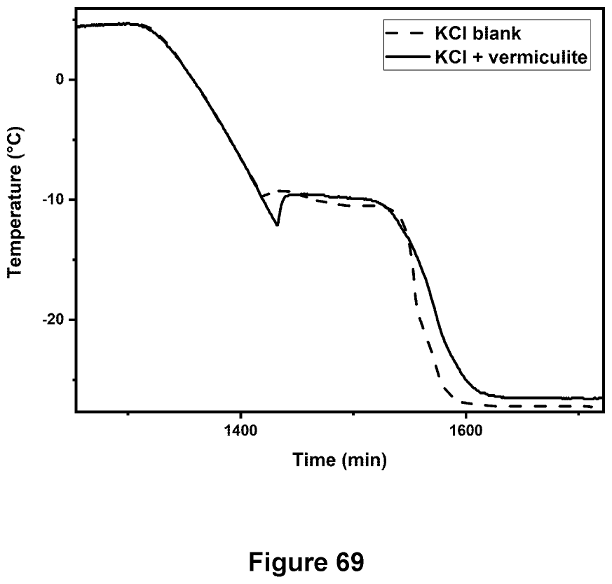

FIG. 69 shows vermiculite improving the second crystallisation of a potassium chloride-water eutectic (approx. 19.5 wt. % KCl in water). The improvement results in a higher temperature, flatter freezing plateau, where the blank has a drop of c.a. 1° C. under the test conditions before flattening out after the initial (1^{st}) crystallisation event.

It is disclosed herein that corrosion of metal components in contact with a salt-water eutectic PCM may be reduced by reduced subcooling by nucleation agent addition. Corrosion is increased where liquid PCM is in contact with metal components, whereas by contrast the solid phase of the same material will have significantly reduced corrosion. Improving the nucleation characteristics of a salt-water eutectic PCM such that less contact is made between liquid PCM and any metallic components, and thereby overall corrosion is limited.

Furthermore, it is disclosed herein that sub-zero PCMs featuring one or more nucleation agent(s) which act to suppress subcooling in one of the PCMs crystallisation events may constitute part of a heat battery apparatus. Thereby, energy storage at subzero temperatures may be achieved with reliable nucleation and the potential for minimal cooling below the thermodynamic phase transition of the PCM component. Cooling of such a system to induce both crystallisation events may proceed via a heat exchanger, or via the addition of a cooling material such as dry ice or liquid nitrogen.

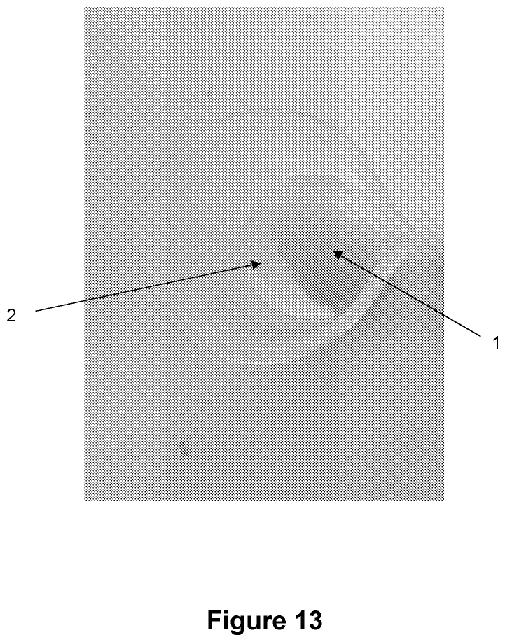

Determination of the state of crystallisation of a sub-zero PCM is also complicated by their double crystallisation characteristics. As they appear solid after the first crystallisation event, it could be concluded at that point that the material has been fully crystallised and may be used in cooling applications. However, it is known to the inventors that to access the full latent heat of the material both crystallisation events must occur. This leads to issues when using such materials, for example in a heat battery apparatus, where the crystallisation state of the material must be known to determine the cooling potential available (i.e. the state of charge of a heat battery comprising such a PCM). Further to the disclosures herein that one or more nucleation agents may be used to ensure that both crystallisation events occur, it is disclosed that full crystallisation may be determined by various means such as, but not limited to, determination of the amount of free water content (i.e. water not bound in a solid form) and optical means. It is disclosed herein that a sub-zero PCM sample may be optically distinct after its first and second crystallisation events. In FIG. 13 a sub-zero PCM which has solidified after its first crystallisation event is undergoing its second crystallisation event, as evidenced by the material turning from a translucent solid (1) into an opaque one (2). Thereby the progress of both crystallisation events may be observed and quantified, for example by optical reflectivity or transmission. This is disclosed to be advantageous in a heat battery comprising a sub-zero PCM where both crystal transitions are required, as it allows confirmation of such.

It is disclosed herein that a PCM with a phase change temperature around −30° C. may be formed by the addition of magnesium nitrate to water to produce about a 29.9 wt. % solution. For this purpose, a hydrated form of magnesium nitrate (e.g. magnesium nitrate hexahydrate) may be used. This solution may then be combined with silica and/or alumina in an amount corresponding to more than 0.1 wt. %, or preferably at least about 0.5 wt. % to aid in the nucleation of the first crystallisation event. This solution may also be combined with silicon carbide in an amount corresponding to more than 0.1 wt. %, or preferably at least about 0.5 wt. % to aid in the nucleation of the second crystallisation event. This material may then be used by thermally cycling it across the phase change at around −30° C. Using this nucleation agent system, the first crystallisation event may occur around −30° C., where the second crystallisation event may occur between about −30° C. and about −40° C.

It is disclosed herein that a PCM with a phase change temperature around −26° C. may be formed by the addition of strontium bromide to water to produce about a 41 wt. % solution. For this purpose, a hydrated form of strontium bromide (e.g. strontium bromide hexahydrate) may be used. This solution may then be combined with calcium carbonate in an amount corresponding to more than 0.1 wt. %, or preferably at least about 0.5 wt. % to aid in the nucleation of the first crystallisation event. This solution may also be combined with silver iodide in an amount corresponding to more than 0.1 wt. %, or preferably at least about 0.5 wt. % to aid in the nucleation of the second crystallisation event. This material may then be used by thermally cycling it across the phase change at around −26° C. Using this nucleation agent system, the first and second crystallisation events may occur between about −26° C. and about −32° C.

It is disclosed herein that a PCM with a phase change temperature around −25° C. may be formed by the addition of sodium bromide to water to produce about a 39 wt. % solution. This solution may then be combined with calcium carbonate in an amount corresponding to more than 0.1 wt %, or preferably at least about 0.5 wt. % to aid in the nucleation of the first crystallisation event. This solution may also be combined with silicon carbide in an amount corresponding to more than 0.1 wt. %, or preferably at least about 0.5 wt. % to aid in the nucleation of the second crystallisation event. This material may then be used by thermally cycling it across the phase change at around −25° C. Using this nucleation agent system, the first and second crystallisation events may occur between about −25° C. and about −33° C.

It is disclosed herein that a PCM with a phase change temperature around −22° C. may be formed by the addition of lithium nitrate to water to produce about a 25 wt. % solution. For this purpose, a hydrated form of lithium nitrate (e.g. lithium nitrate trihydrate) may be used. This solution may then be combined with iron oxide in an amount corresponding to more than 0.1 wt. %, or preferably at least about 0.5 wt. % to aid in the nucleation of the first crystallisation event. This solution may also be combined with silicon carbide in an amount corresponding to more than 0.1 wt. %, or preferably at least about 0.5 wt. % to aid in the nucleation of the second crystallisation event. This material may then be used by thermally cycling it across the phase change at around −22° C. Using this nucleation agent system, the first and second crystallisation events may occur between about −22° C. and about −27° C.

It is disclosed herein that a PCM with a phase change temperature around −21° C. may be formed by the addition of sodium chloride to water to produce about a 22 wt. % solution. This solution may then be combined with calcium carbonate in an amount corresponding to more than 0.1 wt. %, or preferably at least about 0.5 wt. % to aid in the nucleation of the first crystallisation event. This solution may also be combined with silicon carbide and/or vermiculite in an amount corresponding to more than 0.1 wt. %, or preferably at least about 0.5 wt. % to aid in the nucleation of the second crystallisation event. This material may then be used by thermally cycling it across the phase change at around −21° C. Using this nucleation agent system, the first and second crystallisation events may occur between about −21° C. and about −28° C.

It is disclosed herein that a PCM with a phase change temperature around −18° C. may be formed by the addition of sodium acetate to water to produce about a 20-30 wt. % solution, preferably about 23 wt. % or 27 wt. % sodium acetate in water. For this purpose, a hydrated form of sodium acetate (e.g. sodium acetate trihydrate) may be used. This solution may then be combined with calcium carbonate in an amount corresponding to more than 0.1 wt. %, or preferably at least about 0.5 wt. % to aid in the nucleation of the first crystallisation event. This solution may also be combined with silver iodide in an amount corresponding to more than 0.1 wt. %, or preferably at least about 0.5 wt. % to aid in the nucleation of the second crystallisation event. This material may then be used by thermally cycling it across the phase change at around −18° C. Using this nucleation agent system, the first and second crystallisation events may occur between about −18° C. and about −30° C.

It is disclosed herein that a PCM with a phase change temperature around −17° C. may be formed by the addition of sodium nitrate to water to produce about a 35 wt. % solution. This solution may then be combined with iron oxide and/or silica in an amount corresponding to more than 0.1 wt. %, or preferably at least about 0.5 wt. % to aid in the nucleation of the first crystallisation event. This solution may also be combined with aluminium oxide and/or vermiculite in an amount corresponding to more than 0.1 wt. %, or preferably at least about 0.5 wt. % to aid in the nucleation of the second crystallisation event. This material may then be used by thermally cycling it across the phase change at around −17° C. Using this nucleation agent system, the first and second crystallisation events may occur between about −17° C. and about −25° C.

It is disclosed herein that a PCM with a phase change temperature around −16° C. may be formed by the addition of strontium chloride to water to produce about a 20 wt. % solution. For this purpose, a hydrated form of strontium chloride (e.g. strontium chloride hexahydrate) may be used. This solution may then be combined with aluminium oxide in an amount corresponding to more than 0.1 wt. %, or preferably at least about 0.5 wt. % to aid in the nucleation of the first crystallisation event. This solution may also be combined with vermiculite and/or silver iodide in an amount corresponding to more than 0.1 wt. %, or preferably at least about 0.5 wt. % to aid in the nucleation of the second crystallisation event. This material may then be used by thermally cycling it across the phase change at around −16° C. Using this nucleation agent system, the first and second crystallisation events may occur between about −16° C. and about −25° C.

It is disclosed herein that a PCM with a phase change temperature around −15° C. may be formed by the addition of sodium formate to water to produce about a 24 wt. % solution. This solution may then be combined with calcium carbonate in an amount corresponding to more than 0.1 wt. %, or preferably at least about 0.5 wt. % to aid in the nucleation of the first crystallisation event. This solution may also be combined with vermiculite in an amount corresponding to more than 0.1 wt. %, or preferably at least about 0.5 wt. % to aid in the nucleation of the second crystallisation event. This material may then be used by thermally cycling it across the phase change at around −15° C. Using this nucleation agent system, the first and second crystallisation events may occur between about −15° C. and about −20° C.

It is disclosed herein that a PCM with a phase change temperature around −14° C. may be formed by the addition of ammonium chloride to water to produce about a 19 wt. % solution. This solution may then be combined with silver iodide in an amount corresponding to more than 0.1 wt. %, or preferably at least about 0.5 wt. % to aid in the nucleation of the first crystallisation event. This solution may also be combined with vermiculite and/or silicon carbide in an amount corresponding to more than 0.1 wt. %, or preferably at least about 0.5 wt. % to aid in the nucleation of the second crystallisation event. This material may then be used by thermally cycling it across the phase change at around −14° C. Using this nucleation agent system, the first and second crystallisation events may occur between about −14° C. and about −20° C.

It is disclosed herein that a PCM with a phase change temperature around −10° C. may be formed by the addition of potassium chloride to water to produce about a 20 wt. % solution. This solution may then be combined with titanium dioxide and/or silver iodide in an amount corresponding to more than 0.1 wt. %, or preferably at least about 0.5 wt. % to aid in the nucleation of the first crystallisation event. This solution may also be combined with vermiculite in an amount corresponding to more than 0.1 wt. %, or preferably at least about 0.5 wt. % to aid in the nucleation of the second crystallisation event. This material may then be used by thermally cycling it across the phase change at around −10° C. Using this nucleation agent system, the first and second crystallisation events may occur between about −10° C. and about −20° C.

It is disclosed herein that a PCM with a phase change temperature around −5° C. may be formed by the addition of magnesium sulfate to water to produce about a 19 wt. % solution. For this purpose, a hydrated form of magnesium sulfate (e.g. magnesium sulfate heptahydrate) may be used. This solution may then be combined with aluminium oxide and/or silver iodide in an amount corresponding to more than 0.1 wt. %, or preferably at least about 0.5 wt. % to aid in the nucleation of the first crystallisation event. This solution may also be combined with silicon carbide and/or calcium carbonate in an amount corresponding to more than 0.1 wt. %, or preferably at least about 0.5 wt. % to aid in the nucleation of the second crystallisation event. This material may then be used by thermally cycling it across the phase change at around −5° C. Using this nucleation agent system, the first and second crystallisation events may occur between about −5° C. and about −10° C.

It is disclosed herein that a PCM with a phase change temperature around −1° C. may be formed by the addition of sodium sulfate to water to produce about a 4 wt. % solution. For this purpose, a hydrated form of sodium sulfate (e.g. sodium sulfate decahydrate) may be used. This solution may then be combined with silver iodide in an amount corresponding to more than 0.1 wt. %, or preferably at least about 0.5 wt. % to aid in the nucleation of the first crystallisation event. This solution may also be combined with silicon carbide in an amount corresponding to more than 0.1 wt. %, or preferably at least about 0.5 wt. % to aid in the nucleation of the second crystallisation event. This material may then be used by thermally cycling it across the phase change at around −5° C. Using this nucleation agent system, the first and second crystallisation events may occur between about −5° C. and about −10° C.

Whilst various exemplary embodiments have been disclosed, it shall be understood that variations, modifications and combinations of the phase change materials disclosed herein disclosed herein may be made without departing from the scope of the appended claims.

1-58. (canceled)

59. A phase change material (PCM) with a melting point below 0° C. which exhibits at least two crystallisation events on cooling, the PCM comprising:
at least one salt;
water; and
one or more nucleation agent(s) which act to reduce subcooling in a first crystallisation event, and/or
one or more nucleation agent(s) which act to reduce subcooling in a second crystallisation event,
wherein the at least one salt comprises a 1+ halide; if present, the one or more nucleation agent(s) for the first crystallisation event is selected from calcium carbonate, silicon dioxide, aluminium oxide, iron oxide and silver iodide; and, if present, the one or more nucleation agent(s) for the second crystallisation event is selected from silicon carbide and phyllosilicate materials; or
wherein the at least one salt comprises a 2+ halide; if present, the one or more nucleation agent(s) for the first crystallisation event is selected from calcium carbonate, silicon dioxide, aluminium oxide, iron oxide and titanium dioxide; and, if present, the one or more nucleation agent(s) for the second crystallisation event is selected from silicon carbide, vermiculite and silver iodide; or
wherein the at least one salt comprises a sulfate; if present, the one or more nucleation agent(s) for the first crystallisation event is selected from silicon dioxide, aluminium oxide, iron oxide and titanium dioxide; and, if present, the one or more nucleation agent(s) for the second crystallisation event is selected from silicon carbide and calcium carbonate; or
wherein the at least one salt comprises a nitrate; if present, the one or more nucleation agent(s) for the first crystallisation event is selected from calcium carbonate, silicon dioxide, aluminium oxide, iron oxide and titanium dioxide; and, if present, the one or more nucleation agent(s) for the second crystallisation event is selected from silicon carbide, vermiculite and silver iodide; or
wherein the at least one salt comprises a carboxylate; if present, the one or more nucleation agent(s) for the first crystallisation event is selected from calcium carbonate, silicon dioxide, aluminium oxide and iron oxide; and, if present, the one or more nucleation agent(s) for the second crystallisation event is selected from silicon carbide, vermiculite, silver iodide and titanium dioxide.

60. A PCM according to claim 59, wherein the at least one salt is:
a salt of one or more of group I metals, group II metals and/or ammonium salts thereof; or
one or more selected from 1+ halide, 2+ halide, sulfate, nitrate and/or carboxylate salt of a group I metal and/or group II metal.

61. A PCM according to claim 59, wherein the salt(s) is/are comprised of:
at least one or a combination of cations selected from any one of or combination of the following:
Lithium;
Sodium;
Potassium;
Calcium;
Magnesium;
Strontium; and/or
Ammonium
and at least one or a combination of anions selected from:
Chloride;
Bromide;
Sulfate;
Nitrate;
Formate; and/or
Acetate; or
wherein the PCM is comprised of one or more salt(s) selected from any one of or combination of the following:
Between 0 and 10 wt. % sodium sulfate;
Between 0 and 30 wt. % magnesium sulfate;
Between 0 and 40 wt. % magnesium nitrate;
Between 0 and 50 wt. % sodium nitrate;
Between 0 and 35 wt. % lithium nitrate;
Between 0 and 30 wt. % strontium chloride;
Between 0 and 50 wt. % strontium bromide;
Between 0 and 50 wt. % sodium bromide;
Between 0 and 25 wt. % sodium chloride;
Between 0 and 25 wt. % ammonium chloride;
Between 0 and 30 wt. % potassium chloride;
Between 0 and 15 wt. % sodium-potassium tartrate;
Between 0 and 40 wt. % sodium acetate, and/or Between 0 and 35 wt. sodium formate,
with the remainder of each composition being water; or
wherein the PCM is comprised of one or more salt(s) selected from any one of or combination of the following:
Between 3 and 6 wt. % sodium sulfate;
Between 14 and 25 wt. % magnesium sulfate;
Between 25 and 35 wt. % magnesium nitrate;
Between 30 and 40 wt. % sodium nitrate;
Between 20 and 30 wt. % lithium nitrate;
Between 15 and 25 wt. % strontium chloride;
Between 35 and 46 wt. % strontium bromide;
Between 34 and 45 wt. % sodium bromide;
Between 15 and 25 wt. % sodium chloride;
Between 14 and 25 wt. % ammonium chloride;
Between 15 and 25 wt. % potassium chloride;
Between 5 and 15 wt. % sodium-potassium tartrate;
Between 18 and 30 wt. % sodium acetate, and/or Between 19 and 30 wt. % sodium formate,
with the remainder of each composition being water.

62. A PCM according to claim 59, wherein the PCM is comprised of one or more salt(s) selected from one or more of:
About 4 wt. % sodium sulfate;
About 19 wt. % magnesium sulfate;
About 20 wt. % potassium chloride;
About 19 wt. % ammonium chloride;
About 24 wt. % sodium formate;
About 20 wt. % strontium chloride;
About 35 wt. % sodium nitrate;
About 23 wt. % sodium acetate;
About 27 wt. % sodium acetate;
About 22 wt. % sodium chloride;
About 25 wt. % lithium nitrate;
About 39 wt. % sodium bromide;
About 41 wt. % strontium bromide, or
About 30 wt. % magnesium nitrate,
with the remainder of each composition being water.

63. A PCM according to claim 59, wherein, on cooling, the first crystallisation event nucleates at a temperature between 0 and about 10° C., between 0 and about 5° C., or between 0 and about 3° C. below the melting temperature of the PCM; or wherein, on cooling, the second crystallisation event nucleates at a temperature between 0° C. and about 20° C., between 0 and about 10° C., or between 0 and about 5° C. below the melting temperature of the PCM; or
wherein, on cooling, the first crystallisation event nucleates at a temperature between 0° C. and about 10° C. below the melting temperature of the PCM, followed by nucleation of the second crystallisation event at a temperature below about 3° C. below the melting temperature of the PCM.

64. A PCM according to claim 59, wherein the nucleation agent acts to induce crystallisation of the second crystallisation event only; or
wherein the nucleation agent acts to induce crystallisation in the first crystallisation event only; or
wherein a plurality of nucleation agents is used to nucleate both crystallisation events or
wherein one of the crystallisation events is a solid-solid or polymorphic phase transition.

65. A PCM according to claim 59, wherein the nucleation agent is present at a loading of at least 0.01 wt. %, at least 0.1 wt. %, at least 1 wt. %, at least 5 wt. %, or at least 10 wt. %.

66. A PCM according to claim 59, where the PCM volume is more than 1 L, more than 10 L, more than 20 L, more than 100 L, more than 200 L, or more than 1000 L.

67. A PCM according to claim 59, wherein aluminium oxide is used as a nucleation agent for the first crystallisation event, and the salt is selected from a group comprising any one of or combination of the following:
Magnesium sulfate
Potassium chloride
Ammonium chloride
Strontium chloride
Sodium chloride
Sodium bromide; and
Magnesium nitrate.

68. A PCM according to claim 59, wherein calcium carbonate is used as a nucleation agent for the first crystallisation event, and the salt is selected from a group comprising any one of or combination of the following:
Sodium potassium tartrate
Ammonium chloride
Sodium nitrate
Sodium formate
Sodium acetate
Sodium chloride
Sodium bromide; and
Strontium bromide.

69. A PCM according to claim 59, wherein silicon dioxide is used as a nucleation agent for the first crystallisation event, and the salt is selected from a group comprising any one of or combination of the following:
Sodium acetate and
Magnesium nitrate.

70. A PCM according to claim 59, wherein silver iodide is used as a nucleation agent for the first crystallisation event, and the salt is selected from a group comprising any one of or combination of the following:
Ammonium chloride; and
Sodium bromide.

71. A PCM according to claim 59, wherein titanium dioxide is used as a nucleation agent for the first crystallisation event, and the salt is Magnesium sulfate.

72. A PCM according to claim 59, wherein iron oxide is used as a nucleation agent for the first crystallisation event, and the salt is selected from a group comprising any one of or combination of the following:
Sodium nitrate
Sodium acetate; and
Lithium nitrate.

73. A PCM according to claim 59, wherein silicon carbide is used as a nucleation agent for the second crystallisation event, and the salt is selected from a group comprising any one of or combination of the following:
Sodium sulfate
Sodium potassium tartrate
Magnesium sulfate
Ammonium chloride
Sodium formate
Strontium chloride
Sodium nitrate
Sodium acetate
Sodium chloride
Lithium nitrate
Sodium bromide; and
Magnesium nitrate.

74. A PCM according to claim 59, wherein silver iodide is used as a nucleation agent for the second crystallisation event, and the salt is selected from a group comprising any one of or combination of the following:
Sodium formate
Sodium nitrate
Strontium chloride; and
Strontium bromide.

75. A PCM according to claim 59, wherein vermiculite is used as a nucleation agent for the second crystallisation event, and the salt is selected from a group comprising any one of or combination of the following:
Potassium chloride
Ammonium chloride
Sodium formate
Strontium chloride
Sodium nitrate
Sodium acetate
Sodium chloride
Lithium nitrate
Sodium bromide; and
Magnesium nitrate.

76. A PCM according to claim 59, wherein calcium carbonate is used as a nucleation agent for the second crystallisation event, and the salt is magnesium sulfate.

77. A PCM according to claim 59, wherein the PCM comprises about 15-25 wt. % ammonium chloride in water, with the nucleation agent for the first crystallisation event comprising about 0.1-1.0 wt. % silver iodide and the nucleation agent for the second crystallisation event comprising about 0.1-1.0 wt. % vermiculite and/or silicon carbide; and
optionally, wherein the PCM comprises about 18.6 wt. % ammonium chloride in water, with the nucleation agent for the first crystallisation event comprising about 0.5 wt. % silver iodide and the nucleation agent for the second crystallisation event comprising about 0.5 wt. % vermiculite and/or silicon carbide.

78. A PCM according to claim 59, wherein the PCM comprises about 18-30 wt. % sodium formate in water, with the nucleation agent for the first crystallisation event comprising about 0.1-1.0 wt. % calcium carbonate and the nucleation agent for the second crystallisation event comprising about 0.1-1.0 wt. % vermiculite; and
optionally, wherein the PCM comprises about 24 wt. % sodium formate in water, with the nucleation agent for the first crystallisation event comprising about 0.5 wt. % calcium carbonate and the nucleation agent for the second crystallisation event comprising about 0.5 wt. % vermiculite.

79. A PCM according to claim 59, wherein the PCM comprises about 15-25 wt. % strontium chloride in water, with the nucleation agent for the first crystallisation event comprising about 0.1-1.0 wt. % aluminium oxide and the nucleation agent for the second crystallisation event comprising about 0.1-1.0 wt. % vermiculite and/or silver iodide; and
optionally, wherein the PCM comprises about 19.5 wt. % strontium chloride in water, with the nucleation agent for the first crystallisation event comprising about 0.5 wt. % aluminium oxide and the nucleation agent for the second crystallisation event comprising about 0.5 wt. % vermiculite and/or silver iodide.

80. A PCM according to claim 59, wherein the PCM comprises about 30-40 wt. % sodium nitrate in water, with the nucleation agent for the first crystallisation event comprising about 0.1-1.0 wt. % iron oxide and/or silica and the nucleation agent for the second crystallisation event comprising about 0.1-1.0 wt. % vermiculite; and
optionally, wherein the PCM comprises about 35 wt. % sodium nitrate in water, with the nucleation agent for the first crystallisation event comprising about 0.5 wt. % iron oxide and/or silica and the nucleation agent for the second crystallisation event comprising about 0.5 wt. % vermiculite.

81. A PCM according to claim 59, wherein the PCM comprises about 15-30 wt. % sodium acetate in water, with the nucleation agent for the first crystallisation event comprising about 0.1-1.0 wt. % calcium carbonate and the nucleation agent for the second crystallisation event comprising about 0.1-1.0 wt. % silver iodide; and
optionally, wherein the PCM comprises about 22.7 wt. % sodium acetate in water, with the nucleation agent for the first crystallisation event comprising about 0.5 wt. % calcium carbonate and the nucleation agent for the second crystallisation event comprising about 0.5 wt. % silver iodide.

82. A PCM according to claim 59, wherein the PCM comprises about 22-33.0 wt. % sodium acetate in water, with the nucleation agent for the first crystallisation event comprising about 0.1-1.0 wt. % calcium carbonate and the nucleation agent for the second crystallisation event comprising about 0.1-1.0 wt. % silver iodide; and
optionally, wherein the PCM comprises about 27.0 wt. % sodium acetate in water, with the nucleation agent for the first crystallisation event comprising about 0.5 wt. % calcium carbonate and the nucleation agent for the second crystallisation event comprising about 0.5 wt. % silver iodide.

83. A PCM according to claim 59, wherein the PCM comprises about 18-27 wt. % sodium chloride in water, with the nucleation agent for the first crystallisation event comprising about 0.1-1.0 wt. % calcium carbonate and the nucleation agent for the second crystallisation event comprising about 0.1-1.0 wt. % vermiculite and/or silicon carbide; and
optionally, wherein the PCM comprises about 22.4 wt. % sodium chloride in water, with the nucleation agent for the first crystallisation event comprising about 0.5 wt. % calcium carbonate and the nucleation agent for the second crystallisation event comprising about 0.5 wt. % vermiculite and/or silicon carbide.

84. A PCM according to claim 59, wherein the PCM comprises about 19-30 wt. % lithium nitrate in water, with the nucleation agent for the first crystallisation event comprising about 0.1-1.0 wt. % iron oxide and the nucleation agent for the second crystallisation event comprising about 0.1-1.0 wt. % silicon carbide; and
optionally, wherein the PCM comprises about 24.5 wt. % lithium nitrate in water, with the nucleation agent for the first crystallisation event comprising about 0.5 wt. % iron oxide and the nucleation agent for the second crystallisation event comprising about 0.5 wt. % silicon carbide.

85. A PCM according to claim 59, wherein the PCM comprises about 34-45 wt. % sodium bromide in water, with the nucleation agent for the first crystallisation event comprising about 0.1-1.0 wt. % calcium carbonate and the nucleation agent for the second crystallisation event comprising about 0.1-1.0 wt. % silicon carbide; and
optionally, wherein the PCM comprises about 39 wt. % sodium bromide in water, with the nucleation agent for the first crystallisation event comprising about 0.5 wt. % calcium carbonate and the nucleation agent for the second crystallisation event comprising about 0.5 wt. % silicon carbide.

86. A PCM according to claim 59, wherein the PCM comprises about 35-45 wt. % strontium bromide in water, with the nucleation agent for the first crystallisation event comprising about 0.1-1.0 wt. % calcium carbonate and the nucleation agent for the second crystallisation event comprising about 0.1-1.0 wt. % silver iodide; and
optionally, wherein the PCM comprises about 41 wt. % strontium bromide in water, with the nucleation agent for the first crystallisation event comprising about 0.5 wt. % calcium carbonate and the nucleation agent for the second crystallisation event comprising about 0.5 wt. % silver iodide.

87. A PCM according to claim 59, wherein the PCM comprises about 25-35 wt. % magnesium nitrate in water, with the nucleation agent for the first crystallisation event comprising about 0.1-1.0 wt. % silicon dioxide and/or aluminium oxide and the nucleation agent for the second crystallisation event comprising about 0.1-1.0 wt. % silicon carbide; and
optionally, wherein the PCM comprises about 30 wt. % magnesium nitrate in water, with the nucleation agent for the first crystallisation event comprising about 0.5 wt. % silicon dioxide and/or aluminium oxide and the nucleation agent for the second crystallisation event comprising about 0.5 wt. % silicon carbide.
